(19) United States
(12) Patent Application Publication
(10) Pub. No.: US 2026/0359001 A1
(43) Pub. Date: Nov. 12, 2026

(54) SPEECH PREDICTION BASED ON MOTION

(71) Applicant: Apple Inc., Cupertino, CA (US)

(72) Inventors: Thomas G. SALTER, San Francisco, CA (US); Devin W. CHALMERS, Oakland, CA (US); Anna L. BREWER, San Francisco, CA (US)

(21) Appl. No.: 19/656,843

(22) Filed: Apr. 23, 2026

Related U.S. Application Data
(60) Provisional application No. 63/804,555, filed on May 12, 2025.

(51) Int. Cl. G06F 3/16; G06F 3/01

(52) U.S. Cl. CPC G06F 3/165; G06F 3/012; G06F 3/013; G06F 3/017; G06F 3/167

(57) ABSTRACT

Some examples of the disclosure are directed to systems and methods for detecting, via the one or more input devices, a first movement of a first portion of a user of the first computer system; determining a first user intention based on the first movement of the first portion of the user; and in response to determining the first user intention: in accordance with a determination that the first user intention corresponds to a first intention, performing a first action; and in accordance with a determination that the first user intention corresponds to a second intention, different from the first intention, performing a second action, different from the first action.

### CROSS-REFERENCE TO RELATED APPLICATIONS

This application claims the benefit of U.S. Provisional Application No. 63/804,555, filed May 12, 2025, the content of which is herein incorporated by reference in its entirety for all purposes.

### FIELD OF THE DISCLOSURE

This relates generally to devices, systems, and methods of user motion detection. More particularly, the present disclosure addresses context-based user intention determinations.

### BACKGROUND OF THE DISCLOSURE

Some computer graphical environments provide two-dimensional (2D) and/or three-dimensional (3D) environments where at least some objects displayed for a user’s viewing are virtual and generated by a computer. In some examples, a user may interact with these virtual objects (or real objects) in real time (e.g., via air gestures detected by one or more cameras). However, improvements in detecting and interpreting user motions within these environments is desirable.

For instance, certain existing solutions rely on direct user input signals or specialized hardware to capture even simple gestures, which can limit the potential range of interactions of the user. As these environments become more immersive, there is a growing need for more natural, context-aware motion detection that recognizes subtle non-verbal cues (e.g., head tilts, gaze shifts, and/or other user movements or gestures) and translates them into meaningful commands.

### SUMMARY OF THE DISCLOSURE

Some examples of the disclosure are directed to systems, methods, and computer-readable media for detecting, via one or more input devices, a first movement of a first portion of a user of a first computer system. In some examples, the method includes determining a first user intention based on the first movement of the first portion of the user. In some examples, in response to determining the first user intention, in accordance with a determination that the first user intention corresponds to a first intention, the method includes performing a first action. In some examples, in response to determining the first user intention, in accordance with a determination that the first user intention corresponds to a second intention, different from the first intention, the method includes performing a second action, different from the first action.

The full descriptions of these examples are provided in the Drawings and the Detailed Description, and it is understood that this Summary does not limit the scope of the disclosure in any way.

### BRIEF DESCRIPTION OF THE DRAWINGS

For improved understanding of the various examples described herein, reference should be made to the Detailed Description below along with the following drawings. Like reference numerals often refer to corresponding parts throughout the drawings.

FIG. 1 illustrates an electronic device presenting a three-dimensional environment, according to some examples of the disclosure.

FIGS. 2A-2B illustrate block diagrams of example architectures for electronic devices, according to some examples of the disclosure.

FIGS. 3A-3B illustrate an example electronic device performing an action based on a user intention, according to some examples of the disclosure.

FIGS. 4A-4P illustrate an example electronic device performing a plurality of actions based on a plurality of user intentions within a real-life scenario, according to some examples of the disclosure.

FIGS. 5A-5E illustrate flow diagrams of example processes for performing actions based on user intentions, according to some examples of the disclosure.

FIG. 6 illustrates an input/output diagram of a model for determining a user intention based on a movement of a portion of a user, according to some examples of the disclosure.

FIGS. 7A-7C illustrate an example of a first electronic device performing an action based on a user intention determined based on an input detected by a second electronic device, according to some examples of the disclosure.

### DETAILED DESCRIPTION

Some examples of the disclosure are directed to systems, methods, and computer-readable media for detecting, via one or more input devices, a first movement of a first portion of a user of a first computer system. In some examples, the method includes determining a first user intention based on the first movement of the first portion of the user. In some examples, in response to determining the first user intention, in accordance with a determination that the first user intention corresponds to a first intention, the method includes performing a first action. In some examples, in response to determining the first user intention, in accordance with a determination that the first user intention corresponds to a second intention, different from the first intention, the method includes performing a second action, different from the first action.

In some examples, by combining movement data from multiple sensors with contemporaneous device-state information, such as output progress and object-focus context, the first computer system more reliably distinguishes intentional interruption signals from incidental user motion. In some examples, this reduces false detections of user intentions and improves real-time control of output generated by the electronic device, which in turn reduces unnecessary sensor processing and output operations, thereby conserving computational resources and reducing power consumption of the electronic device.

In some examples, a three-dimensional object is displayed in a computer-generated three-dimensional environment with a particular orientation that controls one or more behaviors of the three-dimensional object (e.g., when the three-dimensional object is moved within the three-dimensional environment). In some examples, the orientation in which the three-dimensional object is displayed in the three-dimensional environment is selected by a user of the electronic device or automatically selected by the electronic device. For example, when initiating presentation of the three-dimensional object in the three-dimensional environment, the user may select a particular orientation for the three-dimensional object or the electronic device may automatically select the orientation for the three-dimensional object (e.g., based on a type of the three-dimensional object).

In some examples, a three-dimensional object can be displayed in the three-dimensional environment in a world-locked orientation, a body-locked orientation, a tilt-locked orientation, or a head-locked orientation, as described below. As used herein, an object that is displayed in a body-locked orientation in a three-dimensional environment has a distance and orientation offset relative to a portion of the user’s body (e.g., the user’s torso and/or head). Alternatively, in some examples, a body-locked object has a fixed distance from the user without the orientation of the content being referenced to any portion of the user’s body (e.g., may be displayed in the same cardinal direction relative to the user, regardless of head and/or body movement). Additionally or alternatively, in some examples, the body-locked object may be configured to always remain gravity or horizon (e.g., normal to gravity) aligned, such that head and/or body changes in the roll direction would not cause the body-locked object to move within the three-dimensional environment. Rather, translational movement in either configuration would cause the body-locked object to be repositioned within the three-dimensional environment to maintain the distance offset.

As used herein, an object that is displayed in a head-locked orientation in a three-dimensional environment has a distance and orientation offset relative to the user’s head. In some examples, a head-locked object moves within the three-dimensional environment as the user’s head moves (as a viewpoint of the user changes).

As used herein, an object that is displayed in a world-locked orientation in a three-dimensional environment does not have a distance or orientation offset relative to the user.

As used herein, an object that is displayed in a tilt-locked orientation in a three-dimensional environment (referred to herein as a tilt-locked object) has a distance offset relative to the user, such as a portion of the user’s body (e.g., the user’s torso) or the user’s head. In some examples, a tilt-locked object is displayed at a fixed orientation relative to the three-dimensional environment. In some examples, a tilt-locked object moves according to a polar (e.g., spherical) coordinate system centered at a pole through the user (e.g., the user’s head). For example, the tilt-locked object is moved in the three-dimensional environment based on movement of the user’s head within a spherical space surrounding (e.g., centered at) the user’s head. Accordingly, if the user tilts their head (e.g., upward or downward in the pitch direction) relative to gravity, the tilt-locked object would follow the head tilt and move radially along a sphere, such that the tilt-locked object is repositioned within the three-dimensional environment to be the same distance offset relative to the user as before the head tilt while optionally maintaining the same orientation relative to the three-dimensional environment. In some examples, if the user moves their head in the roll direction (e.g., clockwise or counterclockwise) relative to gravity, the tilt-locked object is not repositioned within the three-dimensional environment.

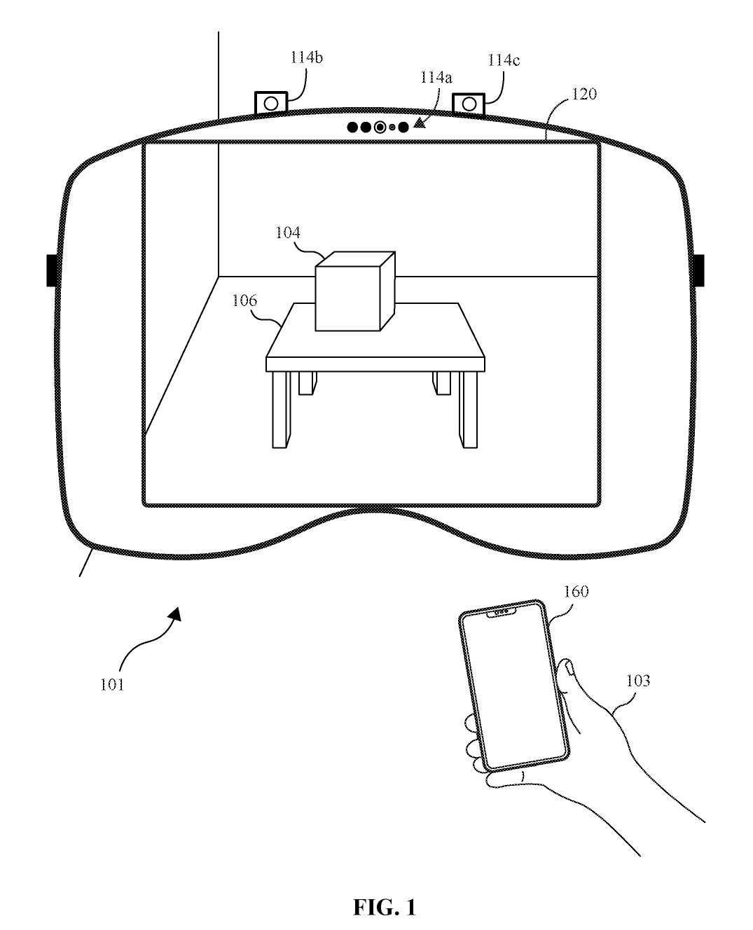

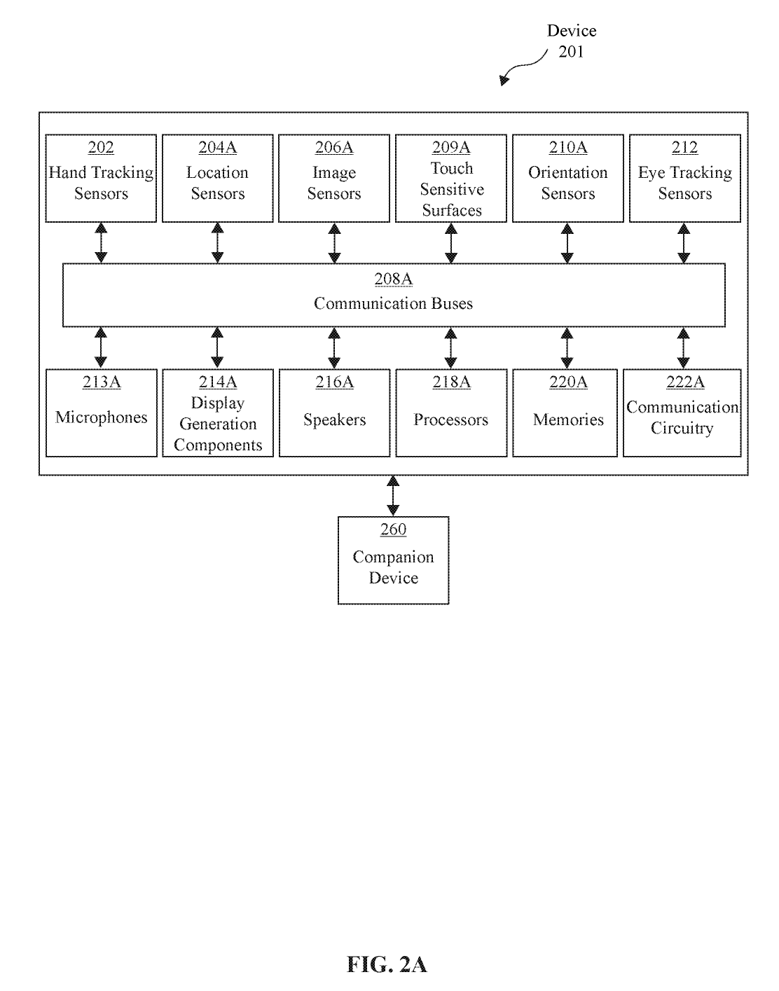

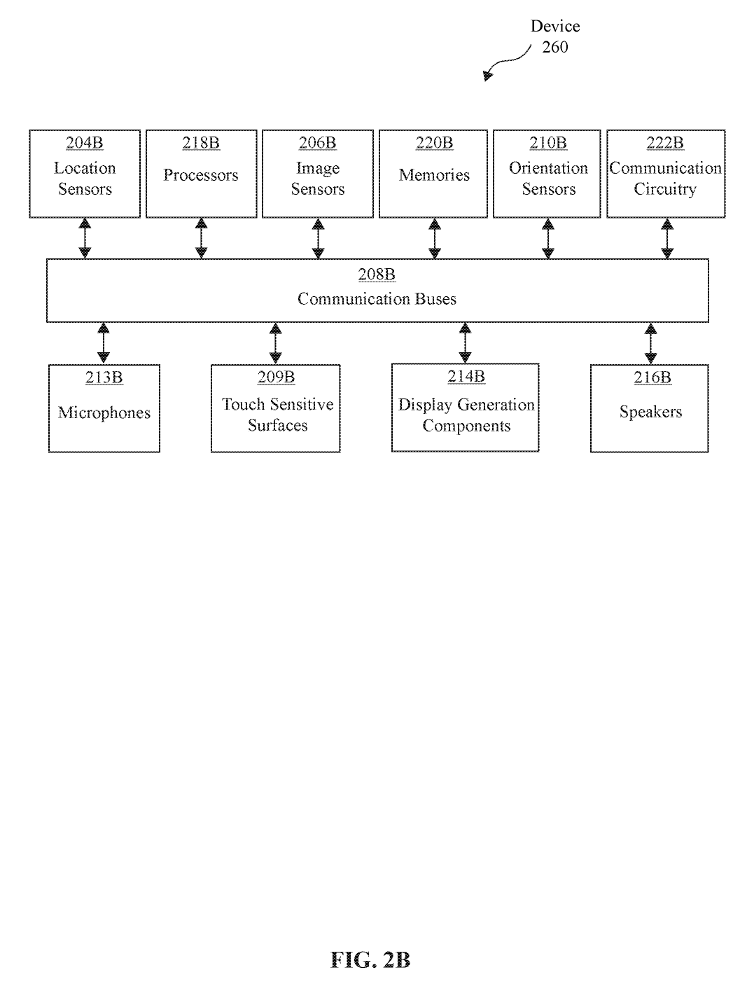

FIG. 1 illustrates an electronic device 101 presenting a three-dimensional environment (e.g., an extended reality (XR) environment or a computer-generated reality (CGR) environment, optionally including representations of physical and/or virtual objects), according to some examples of the disclosure. In some examples, as shown in FIG. 1, electronic device 101 is a head-mounted display or other head-mountable device configured to be worn on a head of a user of the electronic device 101. Examples of electronic device 101 are described below with reference to the architecture block diagram of FIG. 2A. As shown in FIG. 1, electronic device 101 and table 106 are located in a physical environment. The physical environment may include physical features such as a physical surface (e.g., floor, walls) or a physical object (e.g., table, lamp, etc.). In some examples, electronic device 101 may be configured to detect and/or capture images of the physical environment including table 106 (illustrated in the field of view of electronic device 101).

In some examples, as shown in FIG. 1, electronic device 101 includes one or more internal image sensors 114a oriented towards a face of the user (e.g., eye tracking cameras as described below with reference to FIGS. 2A-2B). In some examples, internal image sensors 114a are used for eye tracking (e.g., detecting a gaze of the user). Internal image sensors 114a are optionally arranged on the left and right portions of display 120 to enable eye tracking of the user’s left and right eyes. In some examples, electronic device 101 also includes external image sensors 114b and 114c facing outwards from the user to detect and/or capture the physical environment of the electronic device 101 and/or movements of the user’s hands or other body parts.

In some examples, display 120 has a field of view visible to the user. In some examples, the field of view visible to the user is the same as a field of view of external image sensors 114b and 114c. For example, when display 120 is optionally part of a head-mounted device, the field of view of display 120 is optionally the same as or similar to the field of view of the user’s eyes. In some examples, the field of view visible to the user is different from a field of view of external image sensors 114b and 114c (e.g., narrower than the field of view of external image sensors 114b and 114c). In other examples, the field of view of display 120 may be smaller than the field of view of the user’s eyes. A viewpoint of a user determines what content is visible in the field of view, a viewpoint generally specifies a location and a direction relative to the three-dimensional environment. As the viewpoint of a user shifts, the field of view of the three-dimensional environment will also shift accordingly. In some examples, electronic device 101 may be an optical see-through device in which display 120 is a transparent or translucent display through which portions of the physical environment may be directly viewed. In some examples, display 120 may be included within a transparent lens and may overlap all or a portion of the transparent lens. In other examples, electronic device may be a video-passthrough device in which display 120 is an opaque display configured to display images of the physical environment using images captured by external image sensors 114b and 114c. While a single display is shown in FIG. 1, it is understood that display 120 optionally includes more than one display. For example, display 120 optionally includes a stereo pair of displays (e.g., left and right display panels for the left and right eyes of the user, respectively) having displayed outputs that are merged (e.g., by the user’s brain) to create the view of the content shown in FIG. 1. In some examples, as discussed in more detail below with reference to FIGS. 2A-2B, the display 120 includes or corresponds to a transparent or translucent surface (e.g., a lens) that is not equipped with display capability (e.g., and is therefore unable to generate and display the virtual object 104) and alternatively presents a direct view of the physical environment in the user’s field of view (e.g., the field of view of the user’s eyes).

In some examples, the electronic device 101 is configured to display (e.g., in response to a trigger) a virtual object 104 in the three-dimensional environment. Virtual object 104 is represented by a cube illustrated in FIG. 1, which is not present in the physical environment, but is displayed in the three-dimensional environment positioned on the top of table 106 (e.g., real-world table or a representation thereof). Optionally, virtual object 104 is displayed on the surface of the table 106 in the three-dimensional environment displayed via the display 120 of the electronic device 101 in response to detecting the planar surface of table 106 in the physical environment 100.

It is understood that virtual object 104 is a representative virtual object and one or more different virtual objects (e.g., of various dimensionality such as two-dimensional or other three-dimensional virtual objects) can be included and rendered in a three-dimensional environment. For example, the virtual object can represent an application or a user interface displayed in the three-dimensional environment. In some examples, the virtual object can represent content corresponding to the application and/or displayed via the user interface in the three-dimensional environment. In some examples, the virtual object 104 is optionally configured to be interactive and responsive to user input (e.g., air gestures, such as air pinch gestures, air tap gestures, and/or air touch gestures), such that a user may virtually touch, tap, move, rotate, or otherwise interact with, the virtual object 104.

As discussed herein, one or more air pinch gestures performed by a user (e.g., with hand 103 in FIG. 1) are detected by one or more input devices of electronic device 101 and interpreted as one or more user inputs directed to content displayed by electronic device 101. Additionally or alternatively, in some examples, the one or more user inputs interpreted by the electronic device 101 as being directed to content displayed by electronic device 101 (e.g., the virtual object 104) are detected via one or more hardware input devices (e.g., controllers, touch pads, proximity sensors, buttons, sliders, knobs, etc.) rather than via the one or more input devices that are configured to detect air gestures, such as the one or more air pinch gestures, performed by the user. Such depiction is intended to be exemplary rather than limiting; the user optionally provides user inputs using different air gestures and/or using other forms of input.

In some examples, the electronic device 101 may be configured to communicate with a second electronic device, such as a companion device. For example, as illustrated in FIG. 1, the electronic device 101 is optionally in communication with electronic device 160. In some examples, electronic device 160 corresponds to a mobile electronic device, such as a smartphone, a tablet computer, a smart watch, a laptop computer, or other electronic device. In some examples, electronic device 160 corresponds to a non-mobile electronic device, which is generally stationary and not easily moved within the physical environment (e.g., desktop computer, server, etc.). Additional examples of electronic device 160 are described below with reference to the architecture block diagram of FIG. 2B. In some examples, the electronic device 101 and the electronic device 160 are associated with a same user. For example, in FIG. 1, the electronic device 101 may be positioned on (e.g., mounted to) a head of a user and the electronic device 160 may be positioned near electronic device 101, such as in a hand 103 of the user (e.g., the hand 103 is holding the electronic device 160), a pocket or bag of the user, or a surface near the user. The electronic device 101 and the electronic device 160 are optionally associated with a same user account of the user (e.g., the user is logged into the user account on the electronic device 101 and the electronic device 160). Additional details regarding the communication between the electronic device 101 and the electronic device 160 are provided below with reference to FIGS. 2A-2B.

In some examples, displaying an object in a three-dimensional environment is caused by or enables interaction with one or more user interface objects in the three-dimensional environment. For example, initiation of display of the object in the three-dimensional environment can include interaction with one or more virtual options/affordances displayed in the three-dimensional environment. In some examples, a user’s gaze may be tracked by the electronic device as an input for identifying one or more virtual options/affordances targeted for selection when initiating display of an object in the three-dimensional environment. For example, gaze can be used to identify one or more virtual options/affordances targeted for selection using another selection input. In some examples, a virtual option/affordance may be selected using hand-tracking input detected via an input device in communication with the electronic device. In some examples, objects displayed in the three-dimensional environment may be moved and/or reoriented in the three-dimensional environment in accordance with movement input detected via the input device.

In the descriptions that follows, an electronic device that is in communication with one or more displays and one or more input devices is described. It is understood that the electronic device optionally is in communication with one or more other physical user-interface devices, such as a touch-sensitive surface, a physical keyboard, a mouse, a joystick, a hand tracking device, an eye tracking device, a stylus, etc. Further, as described above, it is understood that the described electronic device, display and touch-sensitive surface are optionally distributed between two or more devices. Therefore, as used in this disclosure, information displayed on the electronic device or by the electronic device is optionally used to describe information outputted by the electronic device for display on a separate display device (touch-sensitive or not). Similarly, as used in this disclosure, input received on the electronic device (e.g., touch input received on a touch-sensitive surface of the electronic device, or touch input received on the surface of a stylus) is optionally used to describe input received on a separate input device, from which the electronic device receives input information.

The device typically supports a variety of applications, such as one or more of the following: a drawing application, a presentation application, a word processing application, a website creation application, a disk authoring application, a spreadsheet application, a gaming application, a telephone application, a video conferencing application, an e-mail application, an instant messaging application, a workout support application, a photo management application, a digital camera application, a digital video camera application, a web browsing application, a digital music player application, a television channel browsing application, and/or a digital video player application.

FIGS. 2A-2B illustrate block diagrams of example architectures for electronic devices according to some examples of the disclosure. In some examples, electronic device 201 and/or electronic device 260 include one or more electronic devices. For example, the electronic device 201 may be a portable device, an auxiliary device in communication with another device, a head-mounted display, a head-worn speaker, etc., respectively. In some examples, electronic device 201 corresponds to electronic device 101 described above with reference to FIG. 1. In some examples, electronic device 260 corresponds to electronic device 160 described above with reference to FIG. 1.

As illustrated in FIG. 2A, the electronic device 201 optionally includes one or more sensors, such as one or more hand tracking sensors 202, one or more location sensors 204A, one or more image sensors 206A (optionally corresponding to internal image sensors 114a and/or external image sensors 114b and 114c in FIG. 1), one or more touch-sensitive surfaces 209A, one or more motion and/or orientation sensors 210A, one or more eye tracking sensors 212, one or more microphones 213A or other audio sensors, one or more body tracking sensors (e.g., torso and/or head tracking sensors), etc. The electronic device 201 optionally includes one or more output devices, such as one or more display generation components 214A, optionally corresponding to display 120 in FIG. 1, one or more speakers 216A, one or more haptic output devices (not shown), etc. The electronic device 201 optionally includes one or more processors 218A, one or more memories 220A, and/or communication circuitry 222A. One or more communication buses 208A are optionally used for communication between the above-mentioned components of electronic device 201.

Additionally, the electronic device 260 optionally includes the same or similar components as the electronic device 201. For example, as shown in FIG. 2B, the electronic device 260 optionally includes one or more location sensors 204B, one or more image sensors 206B, one or more touch-sensitive surfaces 209B, one or more orientation sensors 210B, one or more microphones 213B, one or more display generation components 214B, one or more speakers 216B, one or more processors 218B, one or more memories 220B, and/or communication circuitry 222B. One or more communication buses 208B are optionally used for communication between the above-mentioned components of electronic device 260.

The electronic devices 201 and 260 are optionally configured to communicate via a wired or wireless connection (e.g., via communication circuitry 222A, 222B) between the two electronic devices. For example, as indicated in FIG. 2A, the electronic device 260 may function as a companion device to the electronic device 201. For example, in some examples, the electronic device 260 processes sensor inputs from electronic devices 201 and 260 and/or generates content for display using display generation components 214A of electronic device 201.

Communication circuitry 222A, 222B optionally includes circuitry for communicating with electronic devices, networks, such as the Internet, intranets, a wired network and/or a wireless network, cellular networks, and wireless local area networks (LANs). Communication circuitry 222A, 222B optionally includes circuitry for communicating using near-field communication (NFC) and/or short-range communication, such as Bluetooth®, etc. In some examples, communication circuitry 222A, 222B includes or supports Wi-Fi (e.g., an 802.11 protocol), Ethernet, ultra-wideband ("UWB"), high frequency systems (e.g., 900 MHz, 2.4 GHz, and 5.6 GHz communication systems), or any other communications protocol, or any combination thereof.

One or more processors 218A, 218B include one or more general processors, one or more graphics processors, and/or one or more digital signal processors. In some examples, one or more processors 218A, 218B include one or more microprocessors, one or more central processing units, one or more application-specific integrated circuits, one or more field-programmable gate arrays, one or more programmable logic devices, or a combination of such devices. In some examples, memories 220A and/or 220B are a non-transitory computer-readable storage medium (e.g., flash memory, random access memory, or other volatile or non-volatile memory or storage) that stores computer-readable instructions configured to be executed by the one or more processors 218A, 218B to perform the techniques, processes, and/or methods described herein. In some examples, memories 220A and/or 220B can include more than one non-transitory computer-readable storage medium. A non-transitory computer-readable storage medium can be any medium (e.g., excluding a signal) that can tangibly contain or store computer-executable instructions for use by or in connection with the instruction execution system, apparatus, or device. In some examples, the storage medium is a transitory computer-readable storage medium. In some examples, the storage medium is a non-transitory computer-readable storage medium. The non-transitory computer-readable storage medium can include, but is not limited to, magnetic, optical, and/or semiconductor storages. Examples of such storage include magnetic disks, optical discs based on compact disc (CD), digital versatile disc (DVD), or Blu-ray technologies, as well as persistent solid-state memory such as flash, solid-state drives, and the like.

In some examples, one or more display generation components 214A, 214B include a single display (e.g., a liquid-crystal display (LCD), organic light-emitting diode (OLED), or other types of display). In some examples, the one or more display generation components 214A, 214B include multiple displays. In some examples, the one or more display generation components 214A, 214B can include a display with touch capability (e.g., a touch screen), a projector, a holographic projector, a retinal projector, a transparent or translucent display, etc. In some examples, the electronic device does not include one or more display generation components 214A or 214B. For example, instead of the one or more display generation components 214A or 214B, some electronic devices include transparent or translucent lenses or other surfaces that are not configured to display or present virtual content. However, it should be understood that, in such instances, the electronic device 201 and/or the electronic device 260 are optionally equipped with one or more of the other components illustrated in FIGS. 2A and 2B and described herein, such as the one or more hand tracking sensors 202, one or more eye tracking sensors 212, one or more image sensors 206A, and/or the one or more motion and/or orientations sensors 210A. Alternatively, in some examples, the one or more display generation components 214A or 214B are provided separately from the electronic devices 201 and/or 260. For example, the one or more display generation components 214A, 214B are in communication with the electronic device 201 (and/or electronic device 260), but are not integrated with the electronic device 201 and/or electronic device 260 (e.g., within a housing of the electronic devices 201, 260). In some examples, electronic devices 201 and 260 include one or more touch-sensitive surfaces 209A and 209B, respectively, for receiving user inputs, such as tap inputs and swipe inputs or other gestures (e.g., hand-based or finger-based gestures). In some examples, the one or more display generation components 214A, 214B and the one or more touch-sensitive surfaces 209A, 209B form one or more touch-sensitive displays (e.g., a touch screen integrated with each of electronic devices 201 and 260 or external to each of electronic devices 201 and 260 that is in communication with each of electronic devices 201 and 260).

Electronic devices 201 and 260 optionally include one or more image sensors 206A and 206B, respectively. The one or more image sensors 206A, 206B optionally include one or more visible light image sensors, such as charged coupled device (CCD) sensors, and/or complementary metal-oxide-semiconductor (CMOS) sensors operable to obtain images of physical objects from the real-world environment. The one or more image sensors 206A, 206B also optionally include one or more infrared (IR) sensors, such as a passive or an active IR sensor, for detecting infrared light from the real-world environment. For example, an active IR sensor includes an IR emitter for emitting infrared light into the real-world environment. The one or more image sensors 206A, 206B also optionally include one or more cameras configured to capture movement of physical objects in the real-world environment. The one or more image sensors 206A, 206B also optionally include one or more depth sensors configured to detect the distance of physical objects from electronic device 201, 260. In some examples, information from one or more depth sensors can allow the device to identify and differentiate objects in the real-world environment from other objects in the real-world environment. In some examples, one or more depth sensors can allow the device to determine the texture and/or topography of objects in the real-world environment. In some examples, the one or more image sensors 206A or 206B are included in an electronic device different from the electronic devices 201 and/or 260. For example, the one or more image sensors 206A, 206B are in communication with the electronic device 201, 260, but are not integrated with the electronic device 201, 260 (e.g., within a housing of the electronic device 201, 260). Particularly, in some examples, the one or more cameras of the one or more image sensors 206A, 206B are integrated with and/or coupled to one or more separate devices from the electronic devices 201 and/or 260 (e.g., but are in communication with the electronic devices 201 and/or 260), such as one or more input and/or output devices (e.g., one or more speakers and/or one or more microphones, such as earphones or headphones) that include the one or more image sensors 206A, 206B. In some examples, electronic device 201 or electronic device 260 corresponds to a head-worn speaker (e.g., headphones or earbuds). In such instances, the electronic device 201 or the electronic device 260 is equipped with a subset of the other components illustrated in FIGS. 2A and 2B and described herein. In some such examples, the electronic device 201 or the electronic device 260 is equipped with one or more image sensors 206A, 206B, the one or more motion and/or orientations sensors 210A, 210B, and/or speakers 216A, 216B.

In some examples, electronic device 201, 260 uses CCD sensors, event cameras, and depth sensors in combination to detect the physical environment around electronic device 201, 260. In some examples, the one or more image sensors 206A, 206B include a first image sensor and a second image sensor. The first image sensor and the second image sensor work in tandem and are optionally configured to capture different information of physical objects in the real-world environment. In some examples, the first image sensor is a visible light image sensor, and the second image sensor is a depth sensor. In some examples, electronic device 201, 260 uses the one or more image sensors 206A, 206B to detect the position and orientation of electronic device 201, 260 and/or the one or more display generation components 214A, 214B in the real-world environment. For example, electronic device 201, 260 uses the one or more image sensors 206A, 206B to track the position and orientation of the one or more display generation components 214A, 214B relative to one or more fixed objects in the real-world environment.

In some examples, electronic devices 201 and 260 include one or more microphones 213A and 213B, respectively, or other audio sensors. Electronic device 201, 260 optionally uses the one or more microphones 213A, 213B to detect sound from the user and/or the real-world environment of the user. In some examples, the one or more microphones 213A, 213B include an array of microphones (e.g., a plurality of microphones) that optionally operate in tandem, such as to identify ambient noise or to locate the source of sound in space of the real-world environment.

Electronic devices 201 and 260 include one or more location sensors 204A and 204B, respectively, for detecting a location of electronic device 201 and/or the one or more display generation components 214A and a location of electronic device 260 and/or the one or more display generation components 214B, respectively. For example, the one or more location sensors 204A, 204B can include a global positioning system (GPS) receiver that receives data from one or more satellites and allows electronic device 201, 260 to determine the absolute position of the electronic device in the physical world.

Electronic devices 201 and 260 include one or more orientation sensors 210A and 210B, respectively, for detecting orientation and/or movement of electronic device 201 and/or the one or more display generation components 214A and orientation and/or movement of electronic device 260 and/or the one or more display generation components 214B, respectively. For example, electronic device 201, 260 uses the one or more orientation sensors 210A, 210B to track changes in the position and/or orientation of electronic device 201, 260 and/or the one or more display generation components 214A, 214B, such as with respect to physical objects in the real-world environment. The one or more orientation sensors 210A, 210B optionally include one or more gyroscopes, one or more inertial measurement units (IMUs), and/or one or more accelerometers.

Electronic device 201 includes one or more hand tracking sensors 202 and/or one or more eye tracking sensors 212, in some examples. It is understood, that although referred to as hand tracking or eye tracking sensors, that electronic device 201 additionally or alternatively optionally includes one or more other body tracking sensors, such as one or more leg, one or more torso and/or one or more head tracking sensors. The one or more hand tracking sensors 202 are configured to track the position and/or location of one or more portions of the user’s hands, and/or motions of one or more portions of the user’s hands with respect to the three-dimensional environment, relative to the one or more display generation components 214A, and/or relative to another defined coordinate system. The one or more eye tracking sensors 212 are configured to track the position and movement of a user’s gaze (e.g., a user’s attention, including eyes, face, or head, more generally) with respect to the real-world or three-dimensional environment and/or relative to the one or more display generation components 214A. In some examples, the one or more hand tracking sensors 202 and/or the one or more eye tracking sensors 212 are implemented together with the one or more display generation components 214A. In some examples, the one or more hand tracking sensors 202 and/or the one or more eye tracking sensors 212 are implemented separate from the one or more display generation components 214A. In some examples, electronic device 201 alternatively does not include the one or more hand tracking sensors 202 and/or the one or more eye tracking sensors 212. In some such examples, the one or more display generation components 214A may be utilized by the electronic device 260 to provide a three-dimensional environment and the electronic device 260 may utilize input and other data gathered via the other one or more sensors (e.g., the one or more location sensors 204A, the one or more image sensors 206A, the one or more touch-sensitive surfaces 209A, the one or more motion and/or orientation sensors 210A, and/or the one or more microphones 213A or other audio sensors) of the electronic device 201 as input and data that is processed by the one or more processors 218B of the electronic device 260. Additionally or alternatively, electronic device 260 optionally does not include other components shown in FIG. 2B, such as the one or more location sensors 204B, the one or more image sensors 206B, the one or more touch-sensitive surfaces 209B, etc. In some such examples, the one or more display generation components 214A may be utilized by the electronic device 260 to provide a three-dimensional environment and the electronic device 260 may utilize input and other data gathered via the one or more motion and/or orientation sensors 210A (and/or the one or more microphones 213A) of the electronic device 201 as input.

In some examples, the one or more hand tracking sensors 202 (and/or other body tracking sensors, such as leg, torso and/or head tracking sensors) can use the one or more image sensors 206 (e.g., one or more IR cameras, 3D cameras, depth cameras, etc.) that capture three-dimensional information from the real-world including one or more body parts (e.g., hands, legs, or torso of a human user). In some examples, the hands can be resolved with sufficient resolution to distinguish fingers and their respective positions. In some examples, the one or more image sensors 206A are positioned relative to the user to define a field of view of the one or more image sensors 206A and an interaction space in which finger/hand position, orientation and/or movement captured by the image sensors are used as inputs (e.g., to distinguish from a user’s resting hand or other hands of other persons in the real-world environment). Tracking the fingers/hands for input (e.g., gestures, touch, tap, etc.) can be advantageous in that it does not require the user to touch, hold or wear any sort of beacon, sensor, or other marker.

In some examples, the one or more eye tracking sensors 212 include at least one eye tracking camera (e.g., IR cameras) and/or illumination sources (e.g., IR light sources, such as LEDs) that emit light towards a user’s eyes. The eye tracking cameras may be pointed towards a user’s eyes to receive reflected IR light from the light sources directly or indirectly from the eyes. In some examples, both eyes are tracked separately by respective eye tracking cameras and illumination sources, and a focus/gaze can be determined from tracking both eyes. In some examples, one eye (e.g., a dominant eye) is tracked by one or more respective eye tracking cameras/illumination sources.

Electronic devices 201 and 260 are not limited to the components and configuration of FIGS. 2A-2B, but can include fewer, other, or additional components in multiple configurations. In some examples, electronic device 201 and/or electronic device 260 can each be implemented between multiple electronic devices (e.g., as a system). In some such examples, each of (or more of) the electronic devices may include one or more of the same components discussed above, such as various sensors, one or more display generation components, one or more speakers, one or more processors, one or more memories, and/or communication circuitry. A person or persons using electronic device 201 and/or electronic device 260, is optionally referred to herein as a user or users of the device.

Attention is now directed towards various examples of the present disclosure, which generally relate to detecting user movements and determining user intentions based on those movements. In particular, an electronic device optionally captures data from one or more input devices (e.g., cameras, inertial measurement units (IMUs), and/or other sensors) and uses this data to interpret a user’s motions (e.g., head tilts, hand gestures, and/or gaze shifts). Based on the interpreted intentions, the electronic device optionally performs different actions, such as interrupting or resuming audio output, providing information about an object in a user’s environment, or coordinating with one or more additional electronic devices. As described in further detail below, these methods enable more natural, context-aware interactions that enable a user to communicate non-verbally with an electronic device in a manner that is fluid and intuitive.

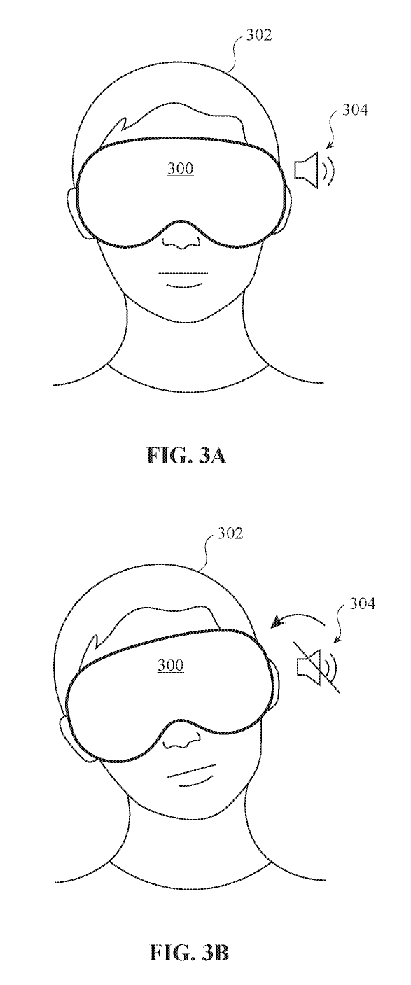

FIGS. 3A-3B illustrate an example electronic device performing an action based on a user intention, according to some examples of the disclosure. FIG. 3A illustrates a user 302 wearing an electronic device 300 (e.g., electronic device 101, 201, or 260; also referred to herein as device 300). In some examples, device 300 is a wearable device (e.g., a head-mounted device). In some examples, device 300 includes one or more input devices (e.g., image sensors 114a-114c, hand tracking sensors 202, location sensors 204A-204B, image sensors 206A-206B, touch-sensitive surfaces 209A-209B, orientation sensors 210A-210B, eye tracking sensors 212, and/or microphones 213A-213B), which device 300 optionally uses to detect movements and/or gestures performed by user 302. Additionally, FIG. 3A illustrates an output 304 that optionally indicates audio is being presented by device 300 (e.g., via speakers 216A-216B). In some examples, output 304 corresponds to a textual output presented by device 300 (e.g., via display 120 or display generation components 214A-214B), or to both an audio and textual output. In some examples, while user 302 is wearing device 300, device 300 presents instructions, notifications, and/or other content to user 302 in the form of output 304.

In some examples, device 300 detects user 302 moving at least a portion of their body (e.g., tilting their head to their right) while wearing device 300, as illustrated in FIG. 3B. In some examples, upon detecting this movement, device 300 determines one or more user intentions based on the detected movement, and optionally performs one or more actions. In some examples, a user intention refers to an inferred user goal or desire indicated by the user’s movement (e.g., a desire to speak, a desire to interrupt output 304, a request for additional information about an object in the environment of user 302, a request to continue or resume output 304, and/or other suitable intents). In some examples, an action refers to an operation device 300 optionally carries out in response to a determined user intention (e.g., ceasing output 304, resuming output 304, adjusting the volume of output 304, providing a textual or graphical explanation, transmitting data to a second device, and/or other suitable operations). For example, as illustrated in FIG. 3B, device 300 optionally interprets the movement (e.g., the head tilt) as an intention to speak, which causes device 300 to cease output 304 in order to avoid talking over user 302 and to facilitate user 302 speaking without competing audio.

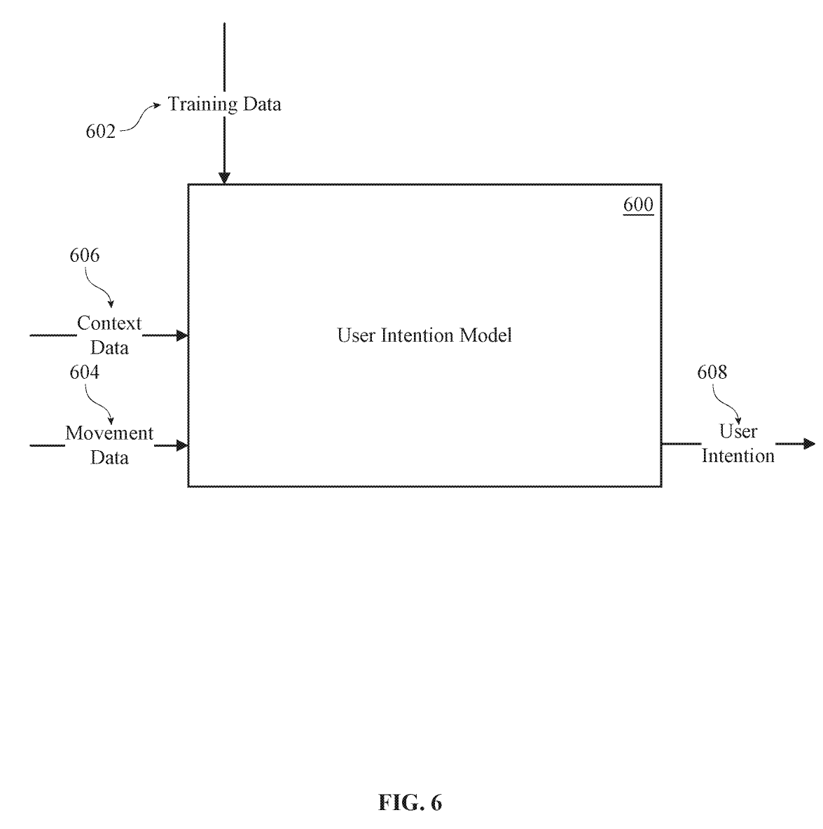

In some examples, device 300 applies threshold-based motion analysis to determine when to perform an action (e.g., interrupt output 304), such as measuring a minimum angle of head tilt or other body movement before ceasing output 304. In some examples, device 300 associates different types and/or magnitudes of detected movement (e.g., a fast head tilt to one side, a slow deliberate nod, a repeated tilt side-to-side, a brief hand wave, an upward head jerk, a hand gesture, and/or other gestures) with different user intentions (e.g., a desire or request to speak or interrupt output 304, a desire or request for clarification, a desire or request to pause or resume an ongoing process, and/or a desire or request to proceed to the next step). In some examples, device 300 uses voice activity detection in combination with one or more detected user movements (e.g., the head tilt) to determine whether to perform an action (e.g., cease or continue output 304). In some examples, device 300 stores historical user movement data (e.g., prior gestures, head tilts, or gaze shifts) to refine subsequent interpretations of similar motions, as described in greater detail with respect to FIG. 6. In some examples, device 300 stores user-defined movement data (e.g., data provided by the user during a registration process) that corresponds to specific user intentions and/or commands (e.g., a user specifying that when they open their mouth, they intend to interrupt the device). In some examples, device 300 presents a visual prompt (e.g., a notification presented via display 120 or display generation components 214A-214B) to indicate that output 304 is paused upon determining an interruption is warranted. In some examples, device 300 detects a second movement (e.g., detecting an opening of the mouth of user 302 via internal image sensors 114a) in addition to the head tilt, thereby reinforcing the user intention to speak.

In some examples, device 300 interprets a single movement as potentially corresponding to multiple different user intentions. For instance, a slight head tilt to the side optionally indicates that the user intends to speak, but the same gesture optionally also indicates mild confusion or an interest in pausing the current output to attend to something else in the environment of user 302. In some examples, device 300 detects additional contextual information (e.g., recent movements, an attention of the user, or voice data) to distinguish between overlapping user intention possibilities. In some examples, device 300 resolves ambiguous signals by incorporating the contextual information such as timing (e.g., how far along is the ongoing output—near the end or near the beginning), the presence of other gestures (e.g., a raised hand or an opening of the mouth), environmental characteristics (e.g., context about the environment of the user, such as being at a concert versus a store or a crowded place versus an empty room) and/or data from historical interactions (e.g., user 302 tends to tilt their head when confused rather than when they want to speak). In some examples, when device 300 cannot confidently assign a single user intention, device 300 prompts user 302 (e.g., via a minimal visual and/or audio cue, such as a subtle beep or flash) to clarify whether user 302 wants to speak, pause, or proceed.

Movements, gestures, and non-verbal cues vary greatly across individual users or cultural contexts. For instance, a quick nod optionally means “yes” in one culture, whereas in a different culture it may mean something else entirely. Similarly, a user optionally has personal habits (e.g., habitual fidgeting, ticks, or subtle head shifts) that do not indicate any intention (e.g., to speak or interrupt). In some examples, to address these differences, device 300 maintains a user-specific profile or data store that captures preferred gestures and/or typical motion patterns over time of user 302 (and/or a culture or other context of user 302). In some examples, device 300 refines the operations performed in response to unique non-verbal cues of user 302 by analyzing how user 302 responds when device 300 initially misinterprets or correctly interprets certain movements. In some examples, device 300 determines whether the user movement(s) have been misinterpreted or correctly interpreted based on one or more of user overrides, voice feedback, and/or subsequent user actions (e.g., user 302 requesting device 300 continue an audio output without having spoken after device 300 interpreted user 302 as wanting to interrupt the audio output to speak).

In some examples, device 300 implements safeguards to differentiate intentional signals from accidental or irrelevant movements. Users optionally move to adjust their posture, scratch their head, or shift their gaze for reasons unrelated to wanting to speak or requesting new information. To avoid constantly interrupting an ongoing output, in some examples, device 300 applies one or more filters and/or threshold checks (e.g., a minimum duration or magnitude for each detected movement) or waits for a second confirming movement before performing an action. In some examples, when device 300 remains uncertain, device 300 presents a minimal visual and/or audio cue to user 302 as described above.

In some examples, device 300 provides a fallback mechanism or manual override so that user 302 is able to correct a misinterpretation. For instance, when device 300 incorrectly halts output 304 because it misread a posture shift of user 302 as an interrupt gesture, user 302 optionally signals a “continue” command (e.g., a voice prompt, such as “keep going,” or another recognized motion) to resume playback. Conversely, when device 300 fails to stop output 304 when the user intends to speak, device 300 can detect user 302 optionally providing input that corresponds to a manual pause (e.g., a “stop” hand gesture). In some examples, device 300 uses these fallback and/or override interactions as data points to refine its interpretation logic over time. For example, device 300 updates a machine learning model (e.g., model 600) based on the fallback and/or override interactions, as described in greater detail with respect to FIG. 6.

The following examples illustrate how device 300 optionally interprets different user movements (e.g., gestures or postures) and responds by performing corresponding actions. It should be understood that these examples are not exhaustive, and any suitable combination of movements, user intentions, and actions is also within the scope of the present disclosure.

In some examples, the user movement corresponds to user 302 opening their mouth or inhaling, the user intention corresponds to an intention to speak, and the action corresponds to device 300 ceasing an ongoing output (e.g., output 304) and optionally activates one or more microphones for speech input.

In some examples, the user movement corresponds to user 302 leaning forward while their attention is directed at an object, the user intention corresponds to a request for more detail on the object, and the action corresponds to device 300 ceasing output 304 and instead presenting an output corresponding to the object (e.g., further information on said object).

In some examples, the user movement corresponds to user 302 tilting their head to one side, the user intention corresponds to an intent to speak or interrupt ongoing output, and the action corresponds to device 300 ceasing ongoing output (e.g., output 304).

In some examples, the user movement corresponds to user 302 tilting their head upward or raising their eyebrows, the user intention corresponds to confusion or curiosity, and the action corresponds to device 300 providing additional explanatory audio or a simplified summary of output 304.

In some examples, the user movement corresponds to user 302 shaking their head vigorously, the user intention corresponds to disagreement or a need to revise instructions, and the action corresponds to device 300 ceasing a current step (e.g., output 304) and/or backtracking to a previous step.

In some examples, the user movement corresponds to user 302 directing their gaze sharply in a different direction or towards a different object, the user intention corresponds to a temporary distraction, and the action corresponds to device 300 lowering volume or pausing an ongoing output (e.g., output 304).

In some examples, the user movement corresponds to user 302 raising a hand partway, the user intention corresponds to an indication that user 302 is about to interject, and the action corresponds to device 300 briefly halting an ongoing output (e.g., output 304) while preparing to receive speech input.

In some examples, the user movement corresponds to user 302 tapping or pointing to an object in the environment, the user intention corresponds to an inquiry about that object, and the action corresponds to device 300 shifting the current discussion or instructions to reference that object.

In some examples, the user movement corresponds to user 302 nodding slowly and deliberately, the user intention corresponds to indicating approval or readiness, and the action corresponds to device 300 continuing or proceeding with ongoing instructions.

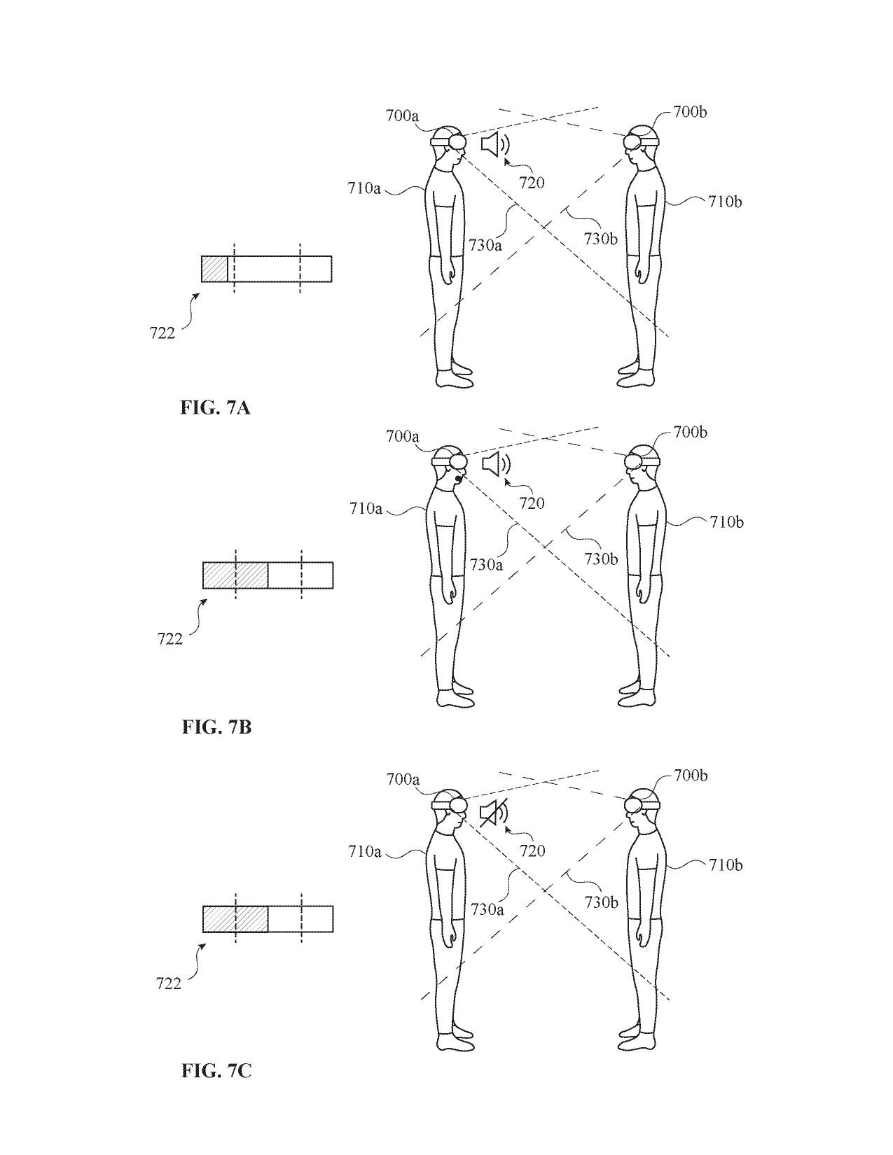

Although FIGS. 3A and 3B illustrate only a single user 302 and a single device 300, any suitable number of users 302 and electronic devices 300 optionally participate in a broader system that detects and responds to user intentions in a similar manner, as described in greater detail with respect to FIGS. 7A-7C. The remaining figures and description below provide further detail regarding example processes that device 300 and similar devices use to optionally interpret user movements and perform corresponding actions.

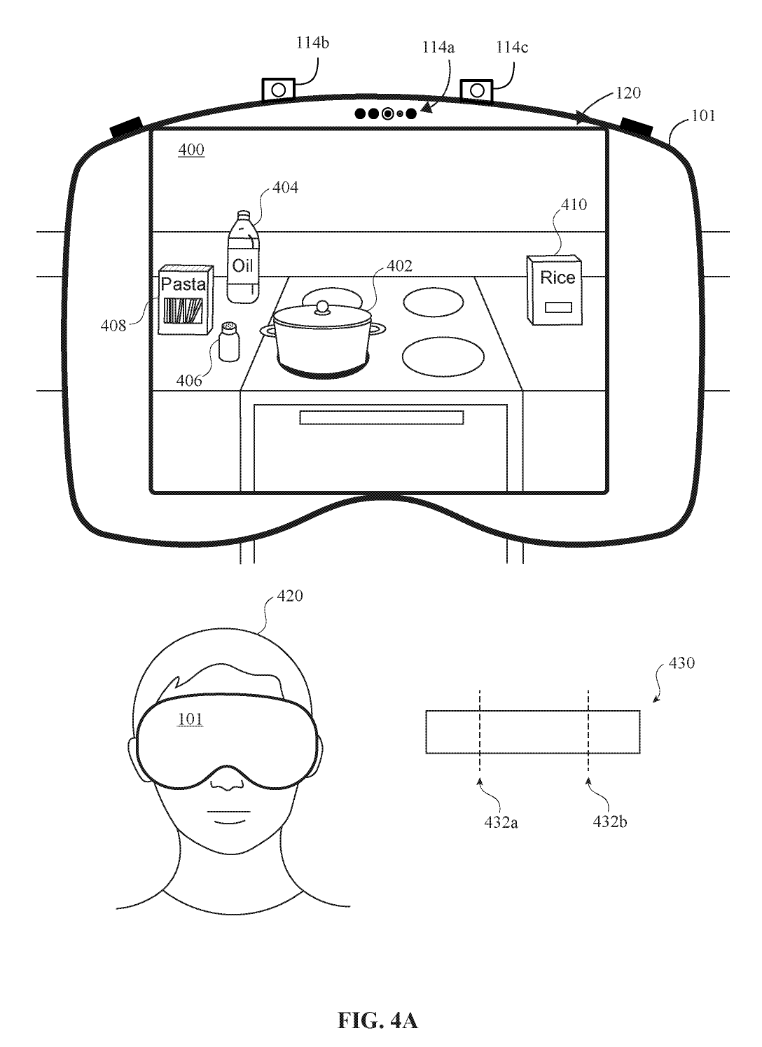

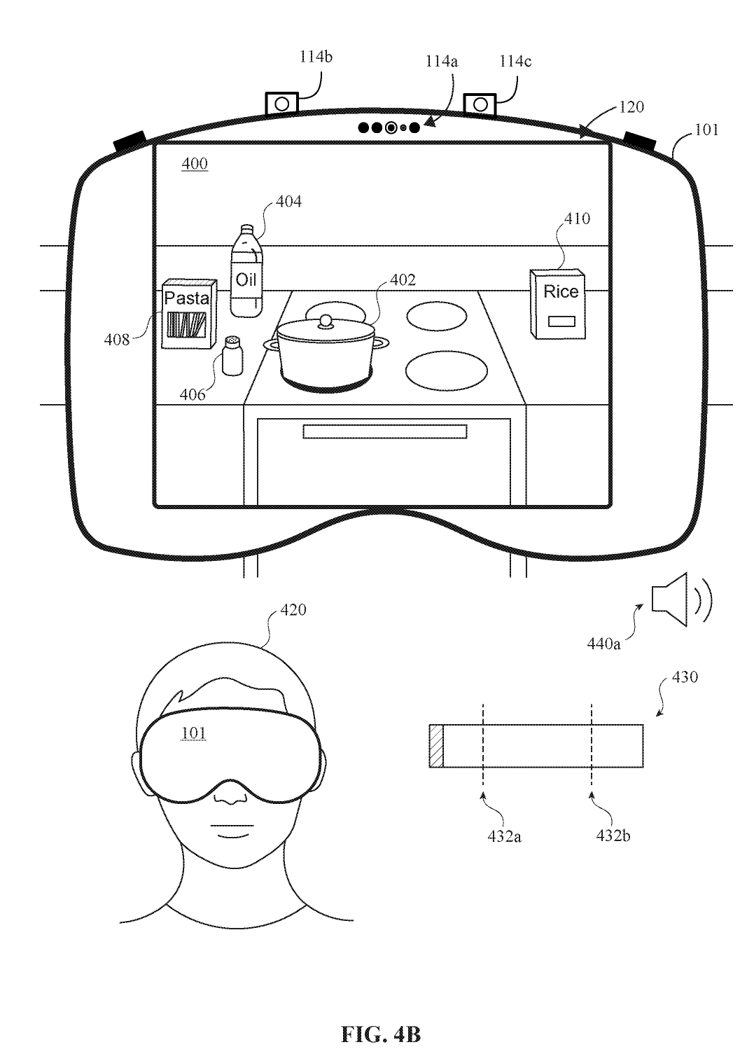

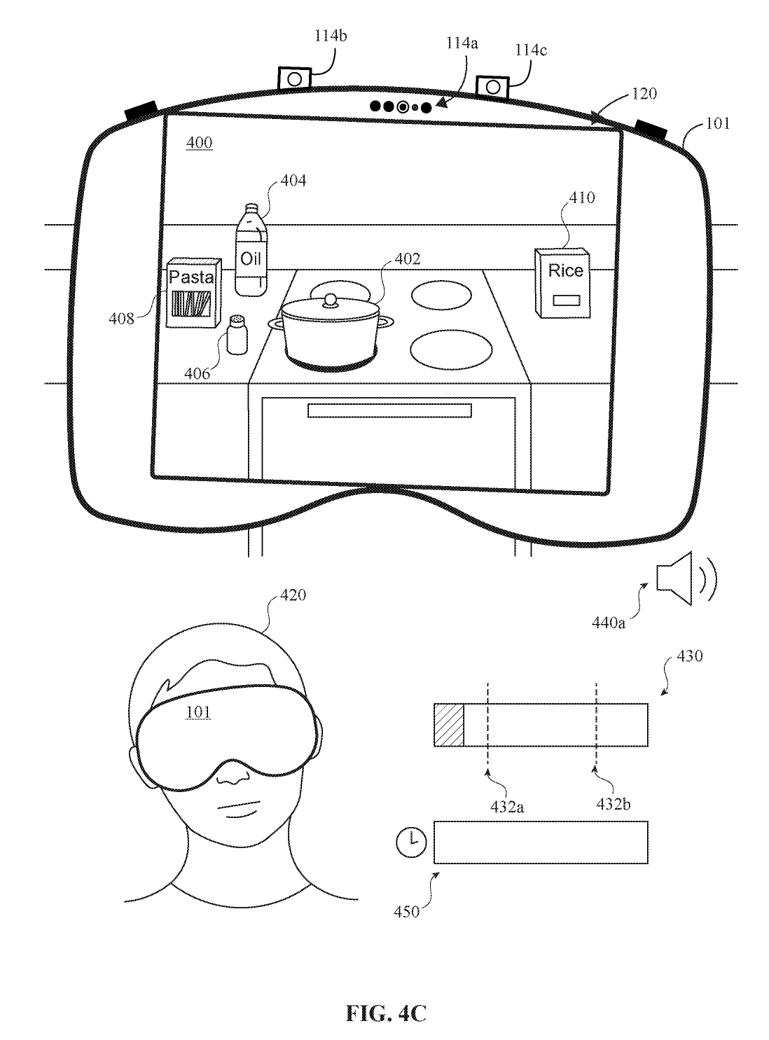

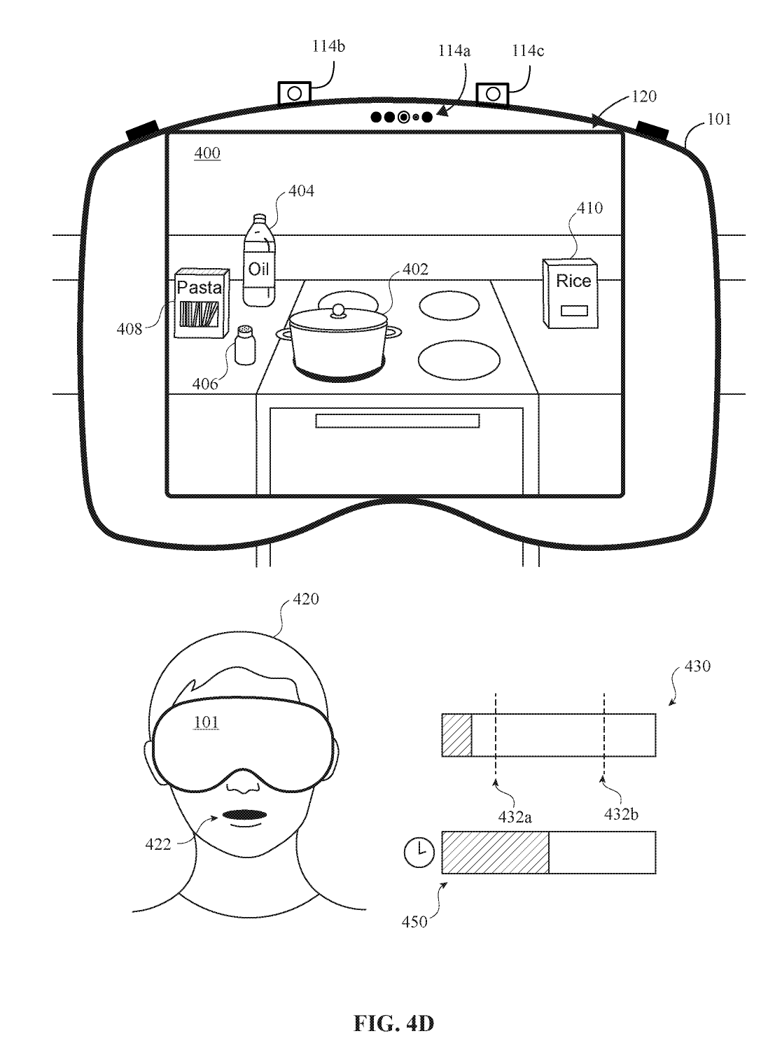

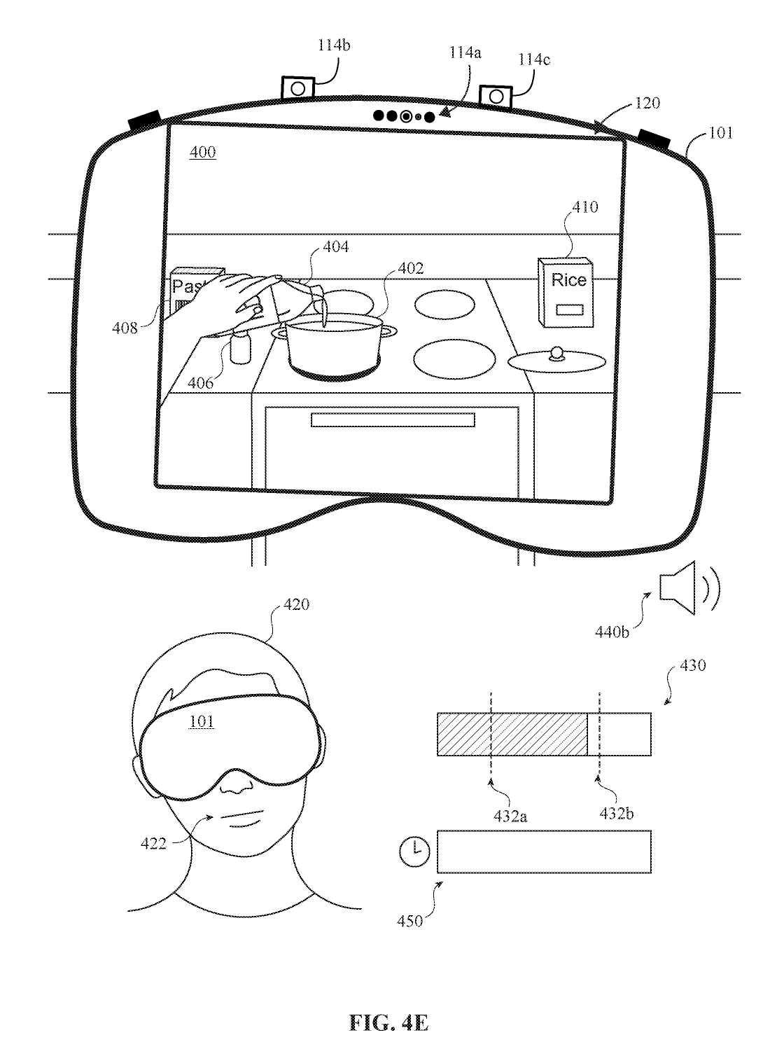

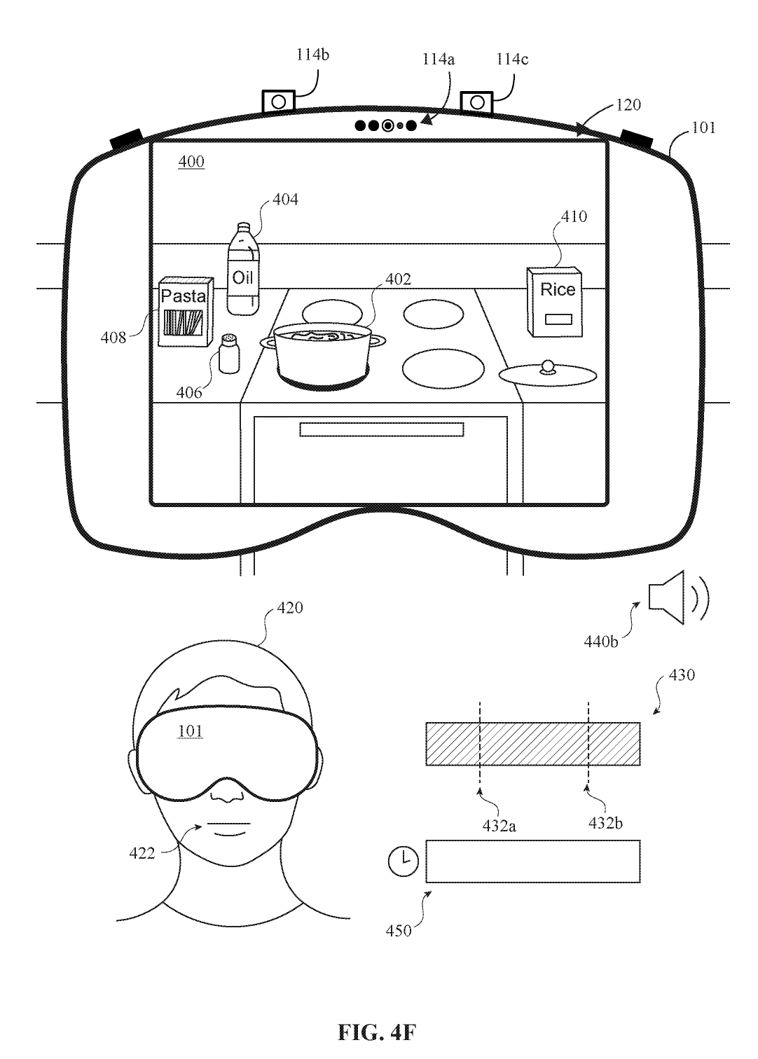

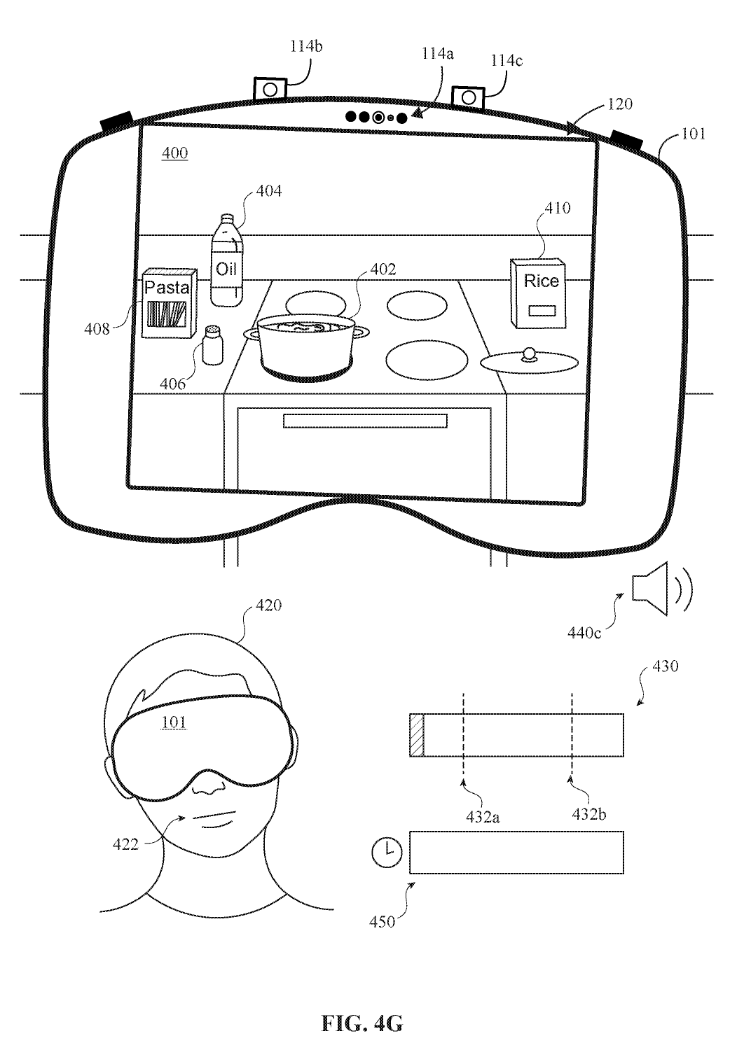

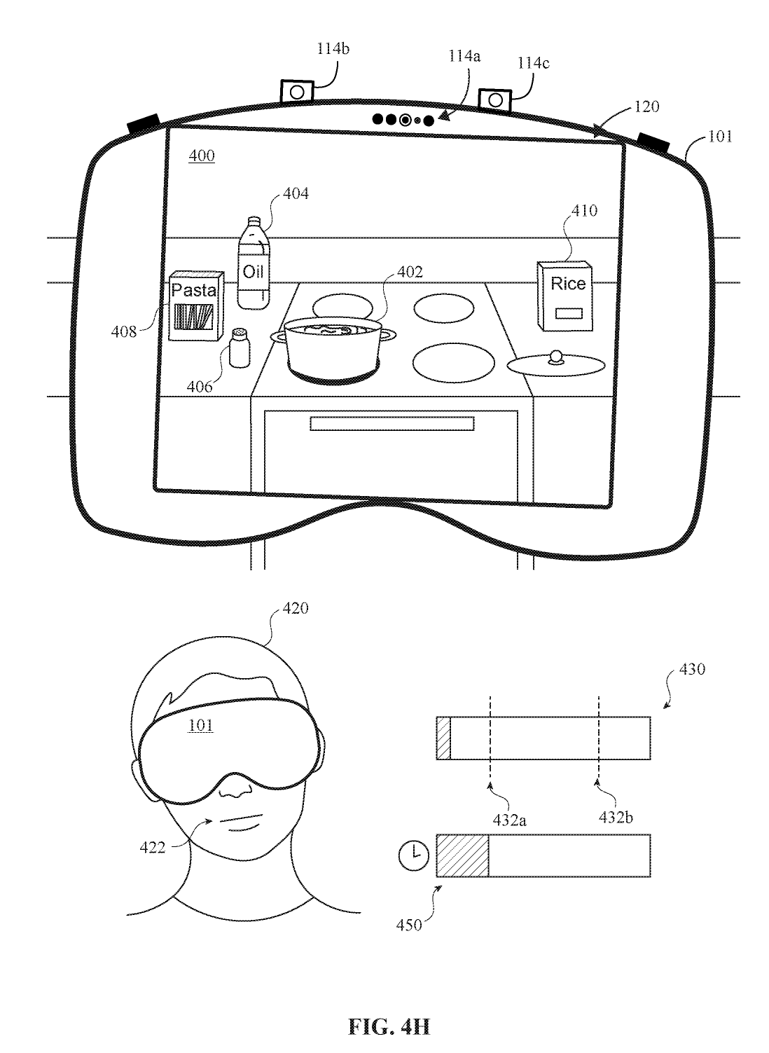

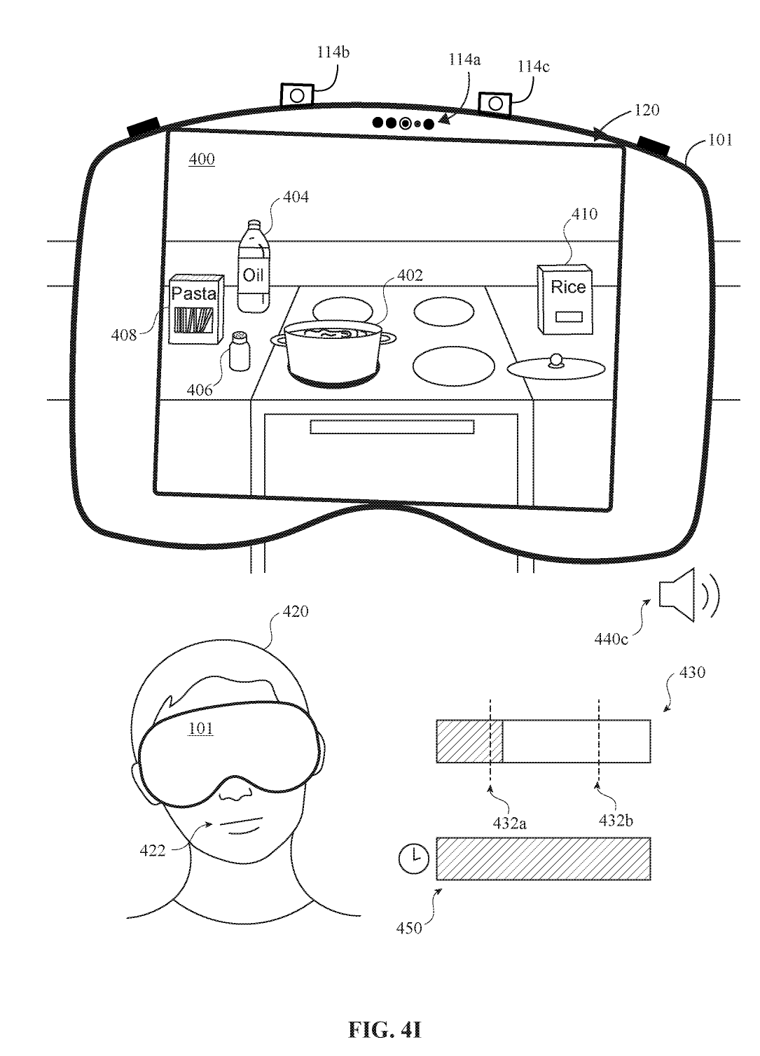

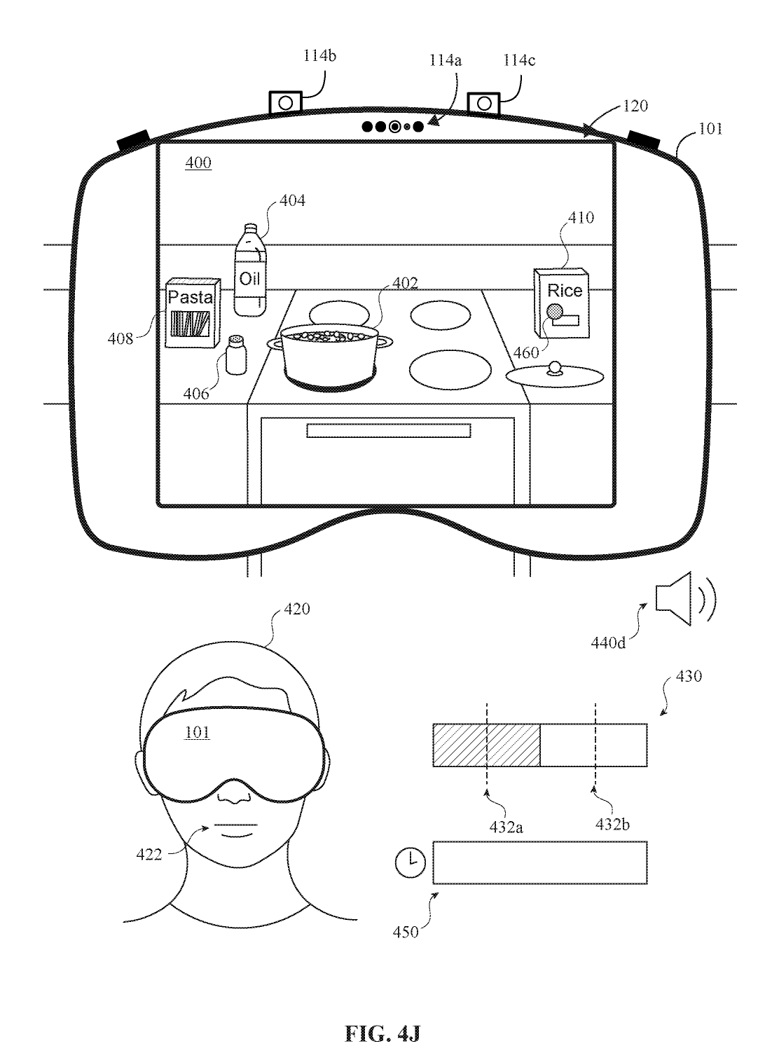

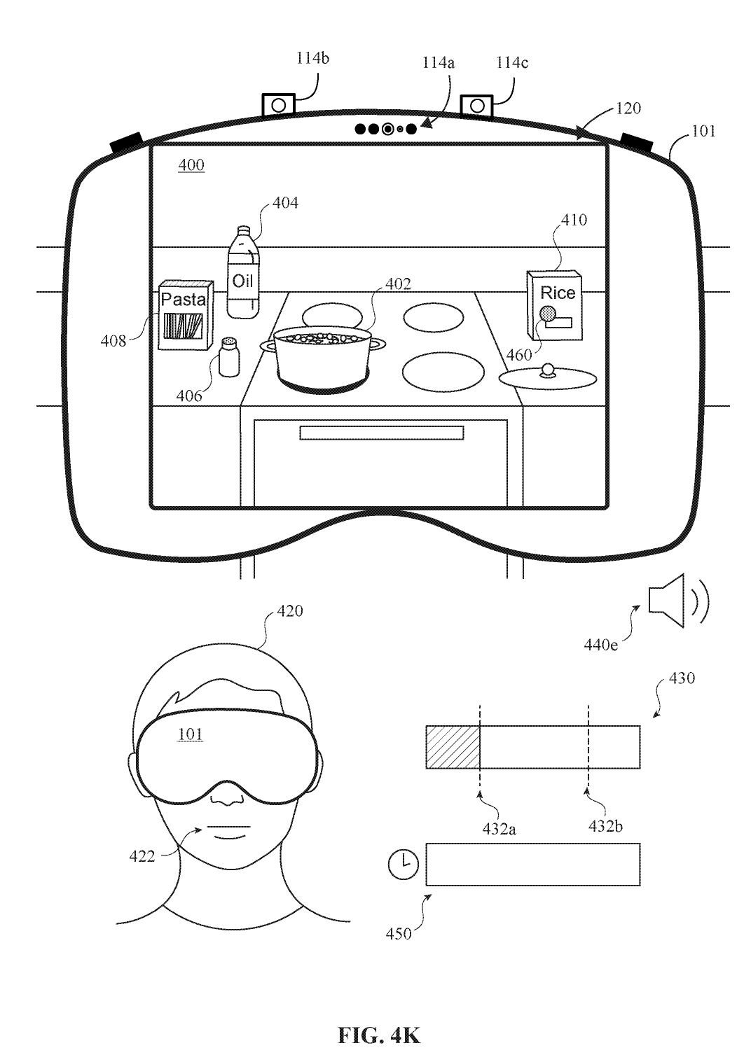

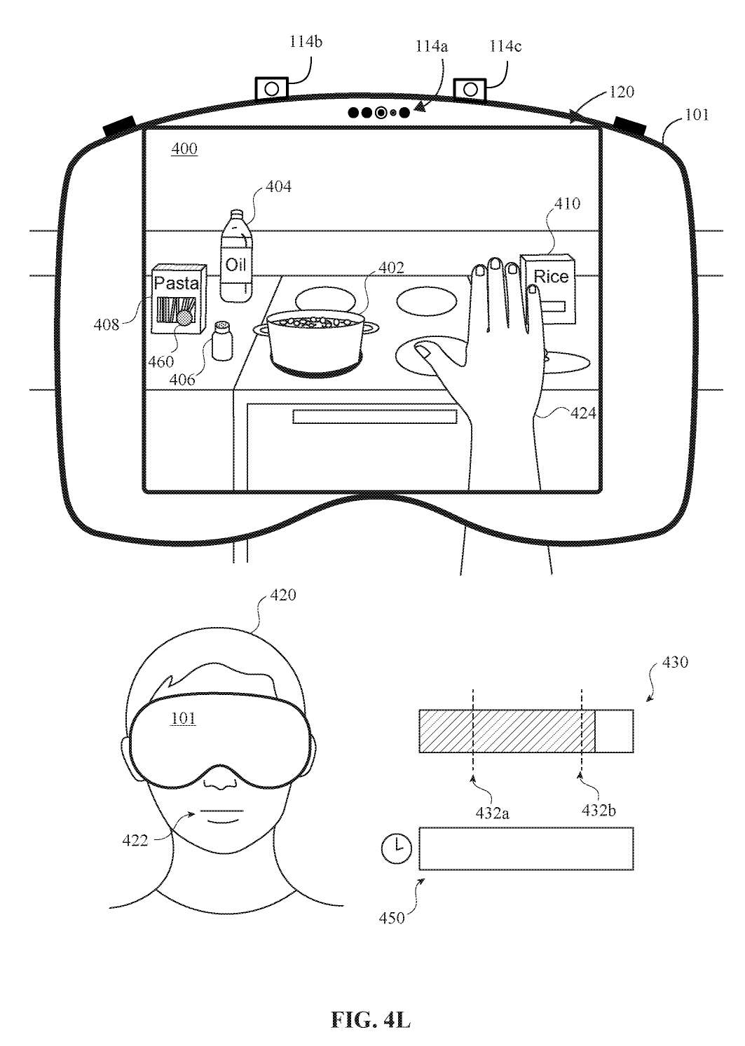

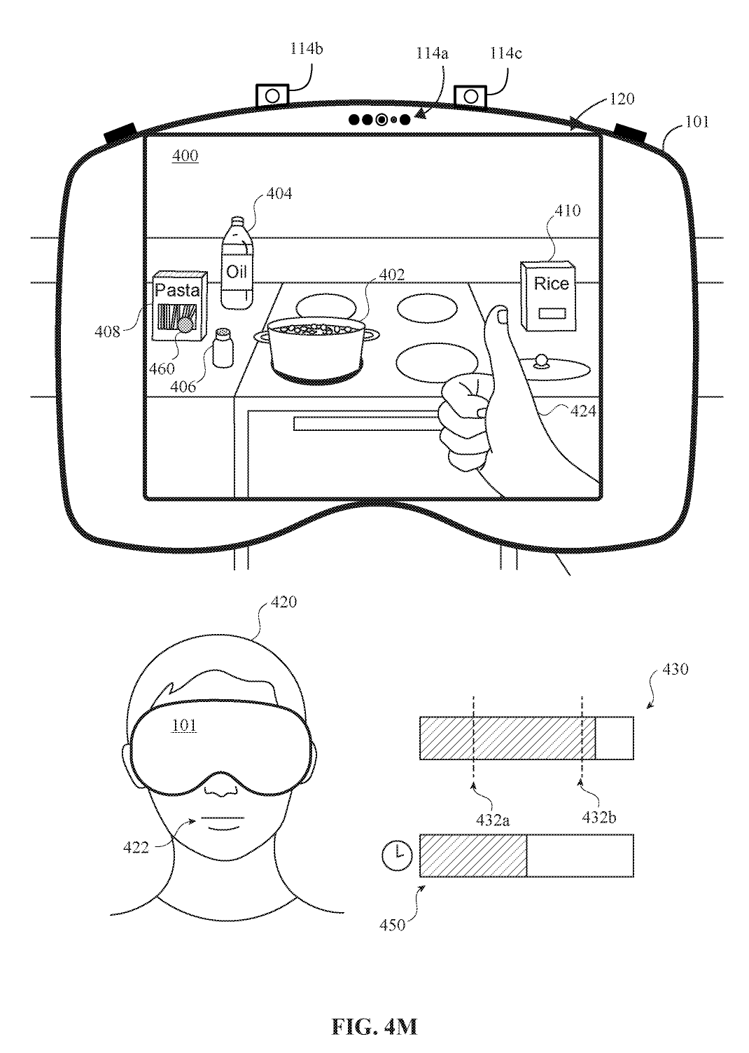

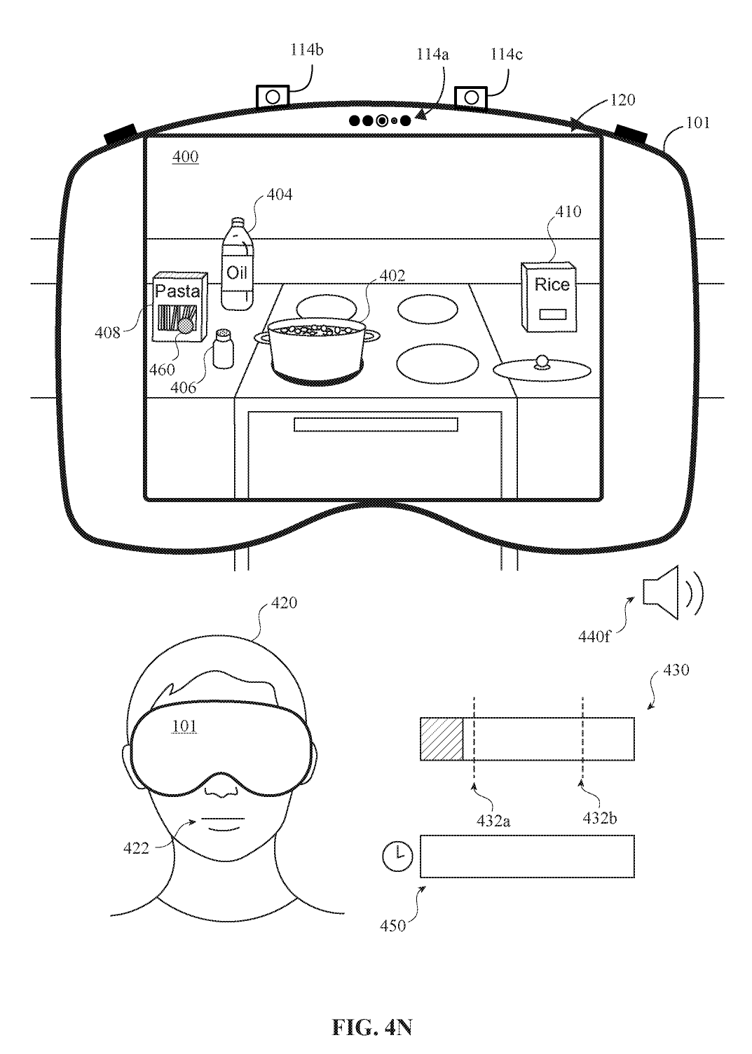

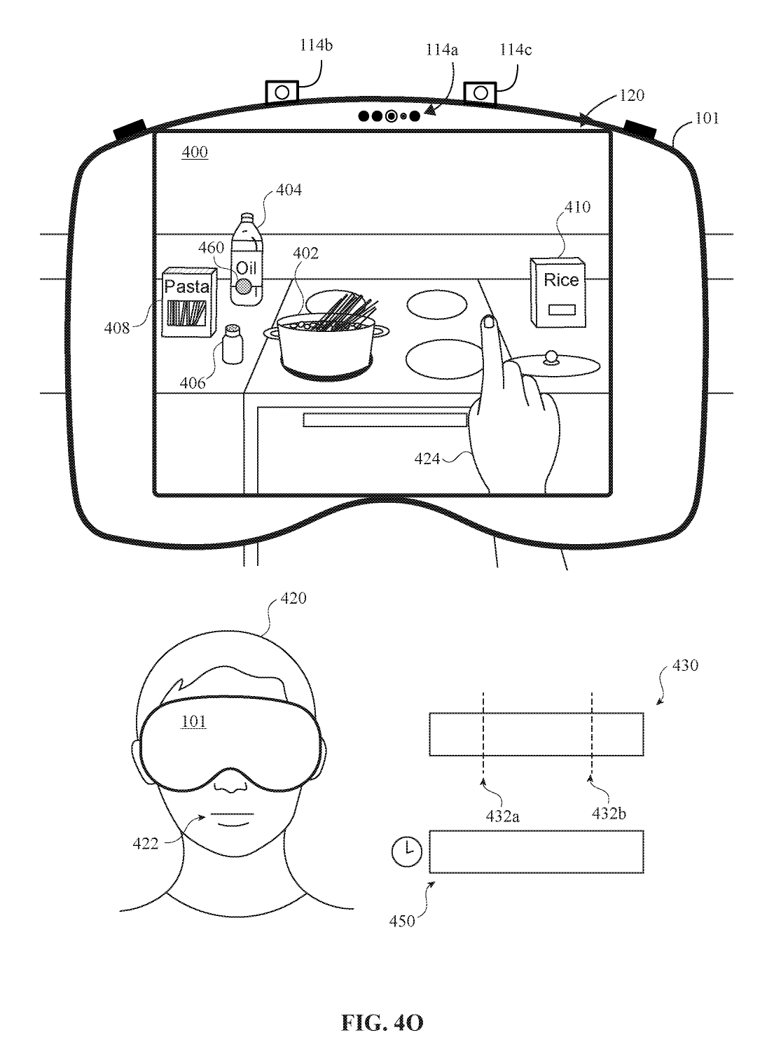

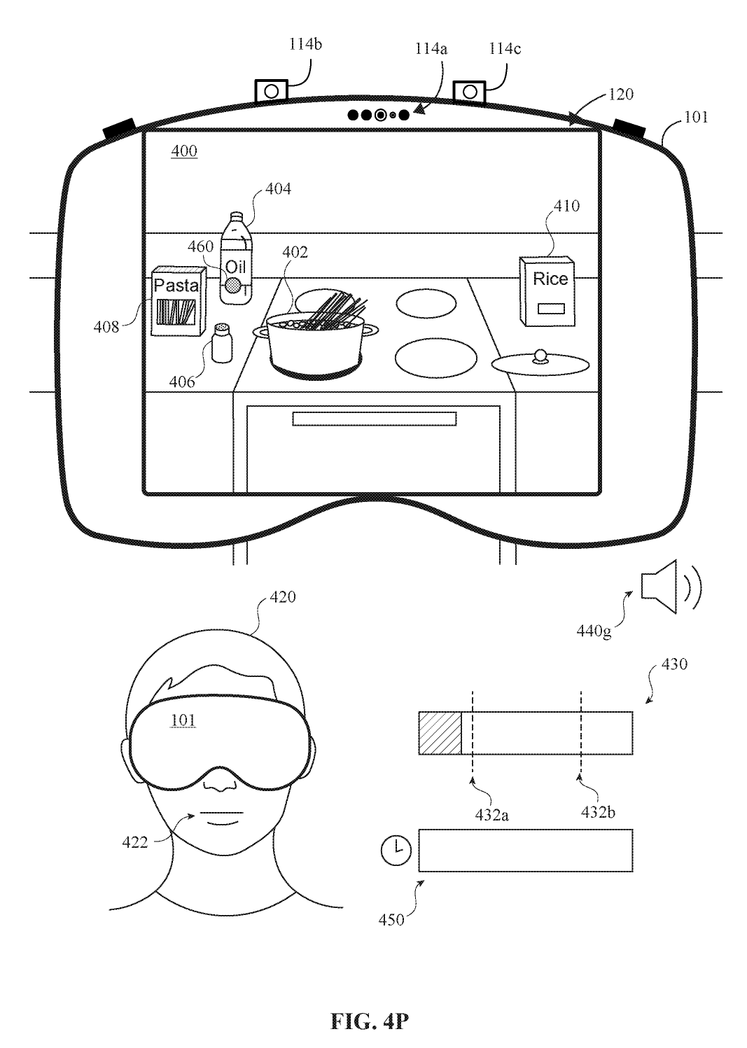

FIGS. 4A-4P illustrate an example electronic device performing a plurality of actions based on a plurality of interpreted user intentions in the context of operation of the electronic device, according to some examples of the disclosure.

FIG. 4A illustrates electronic device 101 presenting, via display 120, a real-world environment 400. In some examples, real-world environment 400 is a representation of the real-world environment surrounding user 420 displayed via display 120. In some examples, real-world environment 400 is a view of the real-world environment surrounding user 420 presented through one or more transparent lenses of device 101. It should be understood that, in some examples, device 101 utilizes one or more techniques described with reference to FIGS. 4A-4P in a three-dimensional environment (e.g., a three-dimensional user interface) or a two-dimensional environment without departing from the scope of the disclosure. As described above with reference to FIGS. 1-2B, device 101 optionally includes a display 120 (or display generation components 214A-214B) (e.g., a head-mounted display), a plurality of image sensors 114a-114c, and additional sensors (e.g., an IMU), as described above. In some examples, image sensors 114a-114c (and/or an IMU) capture gestures or movements of one or more portions of user 420, as described in greater detail herein.

As shown in FIG. 4A, environment 400 includes a pot 402 on a stove, oil 404, salt 406, pasta 408, and rice 410. FIG. 4A also depicts a representative depiction of a real-world environment in which user 420 is shown from the front while wearing device 101. In addition, FIG. 4A depicts an output progress 430 with two progress thresholds 432a-432b (e.g., at 25% and 75% completion). Output progress 430 visually indicates a measure (e.g., a percentage or fraction) of how much of the currently presented output (e.g., audio output 440a) has been delivered by device 101. In some examples, output progress 430 is presented to user 420 via display 120. In some examples, output progress 430 is not presented to user 420.

In some examples, device 101 begins presenting audio output 440a (e.g., “For the first step, you might want to consider pouring some oil into the pot so that the pasta doesn’t stick while it is cooking”) via one or more output devices (e.g., speakers 216A-216B), as illustrated in FIG. 4B. In some examples, device 101 presents a visual output, via display 120, rather than audio output 440a. At a point in time represented by FIG. 4B, a completion progress of audio output 440 is represented as 5% completed by the output progress 430 (e.g., device 101 has so far presented “For the” of audio output 440a and is still presenting the rest of the audio described above).

In some examples, device 101 detects user 420 tilting their head towards their right while device 101 is presenting audio output 440a, as illustrated in FIG. 4C. At the point in time represented by FIG. 4C, the output progress 430 is at 15% (e.g., device 101 has so far presented “For the first step, you might wa-” of audio output 440a). In some examples, upon detecting user 420 tilting their head, device 101 begins tracking the time elapsed since detecting the user movement, as illustrated by time elapsed 450 (e.g., to defer a final determination of whether a user intention determined from the user movement is correct). In some examples, when device 101 detects the time elapsed 450 is equal to or greater than a threshold (e.g., the bar representing the time elapsed 450 is filled) (e.g., 0.5 s, 1 s, 2 s, 5 s, 10 s), device 101 optionally performs or does not perform an action, as described in greater detail herein. For example, upon detecting the user movement (e.g., the head tilt), device 101 determines a user intention to interrupt, temporarily ceases audio output 440a, and starts tracking the time elapsed 450; when the time elapsed 450 exceeds a respective threshold (e.g., 2 seconds) without the user confirming the interrupt (e.g., speaking or reinforcing the tilt), device 101 concludes the tilt was not a genuine interrupt signal and resumes audio output 440a, whereas when device 101 confirms the user intention before time elapsed 450 exceeds the respective threshold (e.g., starts speaking), device 101 persists in the interrupt state (e.g., continuing to pause audio output 440a or completely stopping audio output 440a). Some examples of actions performed by device 101 when the time elapsed 450 exceeds the threshold include, but are not limited to, resuming or continuing audio output 440a (e.g., when device 101 had paused audio output 440a upon detecting a potential interrupt), adjusting the volume of audio output 440a, switching to a different output mode (e.g., from audio to visual), prompting user 420 to confirm or dismiss the unconfirmed movement, halting or pausing other ongoing processes, and/or re-checking sensor data to finalize interpretation of the movement.

In some examples, upon detecting user 420 tilting their head, device 101 ceases presenting audio output 440a, as illustrated in FIG. 4D. In some examples, ceasing to present audio output 440a refers to pausing audio output 440a (as shown by the output progress 430 remaining at 15%), rather than terminating audio output 440a altogether (e.g., in case user 420 wishes to resume audio output 440a and/or device 101 misinterpreted the user intention behind the head tilt of user 420).

In some examples, device 101 determines an intention of user 420 is to speak (or interrupt) based on a combination of the head tilt, the output progress 430 being below progress threshold 432a (e.g., interruption is more likely at an early state of the audio output), and/or mouth 422 of user 420 being open. In some examples, device 101 uses the combination of the head tilt, the output progress 430, and/or the state of mouth 422 (and/or other suitable context, as described in greater detail herein) to determine an interruption confidence score (e.g., a score from 0 to 1, where 1 is absolutely confident and 0 is not confident) that the intention of user 420 is to interrupt audio output 440a (or a different intention). In some examples, upon determining the interruption confidence score, device 101 compares the interruption confidence score to an interruption confidence threshold to determine whether to cease or continue presenting audio output 440a (or perform a different action).

In the example illustrated in FIG. 4D, device 101 was correct to cease presenting audio output 440a, given that user 420 opened mouth 422 to say (“Can you speak faster and more to the point?”). In some examples, given that the time elapsed 450 is not equal to or greater than the threshold (e.g., the time elapsed 450 is at 50%) before confirming the user intention (e.g., user 420 begins to speak), device 101 stops tracking the time elapsed 450 and does not perform an action associated with the time elapsed 450. In some examples, because user 420 spoke before the time elapsed 450 exceeded the threshold, device 101 determined the user’s intention was confirmed by their speech, maintained the cessation of audio output 440a and stopped tracking the time elapsed 450. In some examples, when device 101 determines the time elapsed 450 exceeds the threshold before confirming the user intention, device 101 resumes audio output 440a (e.g., determining that the user movement was not a genuine interrupt).

In some examples, in response to detecting the user speak (and finish their speech), device 101 begins presenting audio output 440b (e.g., “Understood. First, pour a tablespoon of oil into the pot.”), as illustrated in FIG. 4E, which also illustrates device 101 detecting user 420 tilting their head. At the point in time represented in FIG. 4E, the output progress 430 is at 70% (e.g., device 101 has so far presented “Understood. First, pour a tablespoon of oil” of audio output 440b) and the time elapsed 450 is at 0%.

In some examples, device 101 determines an intention of user 420 is not to speak (e.g., the head tilt was not an indication of a user intention to interrupt audio output 440b) based on a combination of the head tilt, the output progress 430 being above progress threshold 432a (e.g., interruption is less likely at a middle or later state of the audio output), and/or mouth 422 being closed. In some examples, device 101 employs the confidence score assessment described above to determine whether to cease or continue presenting audio output 440b (or perform a different action).

In the example illustrated in FIG. 4F, device 101 was correct to continue presenting audio output 440b (e.g., as shown by the output progress 430 reaching 100% completion), given that user 420 did not intend to speak, despite tilting their head as in FIG. 4C. In some examples, upon determining the intention of user 420 is not to speak, device 101 stops tracking (or does not track from the beginning) the time elapsed 450 (e.g., as illustrated by the time elapsed 450 remaining at 0% despite time passing between FIGS. 4E and 4F).

In some examples, device 101 begins presenting (e.g., in response to detecting user 420 has completed the step—the oil is in the water of pot 402) audio output 440c (e.g., “Next, add a large pinch of salt.”), as illustrated in FIG. 4G, which also illustrates device 101 detecting user 420 tilting their head. In some examples, device 101 detects user 420 has completed a previous step by analyzing sensor data (e.g., analyzing data from one or more cameras and/or sensors to confirm oil 404 has been dispensed into pot 402), detecting a visual or verbal cue from user 420 (e.g., detecting user 420 saying “Done” or performing a respective hand gesture), detecting relevant object state changes (e.g., detecting, via one or more sensors, the contents of pot 402 having changed), and/or logging a threshold elapsed time since the prior instruction was output. At the point in time represented in FIG. 4G, the output progress 430 is at 5% (e.g., device 101 has so far presented “Ne-” of audio output 440c) and the time elapsed 450 is at 0%.

In some examples, device 101 determines an intention of user 420 is to speak (or interrupt) based on a combination of the head tilt, the output progress 430 being below progress threshold 432a, and/or mouth 422 being closed and ceases presenting audio output 440c, as illustrated in FIG. 4H. In some examples, device 101 employs the confidence score assessment described above (e.g., the interruption confidence score is still above the interruption confidence threshold despite mouth 422 being closed) to determine whether to cease or continue presenting audio output 440c (or perform a different action). At the point in time represented in FIG. 4H, the output progress 430 remains at 5% (e.g., device 101 merely paused audio output 440c in case user 420 wishes audio output 440c to resume) and the time elapsed 450 is at 25%.

In some examples, upon detecting the time elapsed 450 is equal to or greater than the threshold (e.g., the bar representing the time elapsed 450 is full), device 101 determines its assessment of the user intention was incorrect (or user 420 has changed their mind about interrupting audio output 440c) and resumes presenting audio output 440c (e.g., as shown by the output progress 430 advancing to 30% completion), as illustrated in FIG. 4I. In some examples, resuming presenting audio output 440c refers to device 101 presenting audio output 440c starting at the same point where audio output 440c was paused (e.g., output progress 430 at 5%). In some examples, resuming presenting audio output 440c includes device 101 determining whether audio output 440c should restart from the beginning (e.g., output progress 430 at 0%) based on one or more contextual factors (e.g., audio output 440c would be hard to comprehend if resumed at the point where audio output 440c was paused, such as audio output 440c being paused in the middle of a word or early in its progress).

In some examples, device 101 begins presenting (e.g., in response to detecting a change in one or more environmental characteristics—the water in pot 402 is boiling) audio output 440d (e.g., “Add the pasta now that the water is boiling.”), as illustrated in FIG. 4J. At the point in time represented in FIG. 4J, the output progress 430 is at 50% (e.g., device 101 has so far presented “Add the pasta now” of audio output 440d). In some examples, device 101 detects an attention of user 420 (e.g., attention 460 of user 420) directed at rice 410.

In some examples, in response to detecting attention 460 of user 420 directed at rice 410 while presenting audio output 440d (which is directed instead to pasta 408), device 101 ceases presenting audio output 440d and instead begins presenting audio output 440e (e.g., “You seem to be looking at rice; the pasta is on your left.”), as illustrated in FIG. 4K. At the point in time represented in FIG. 4K, the output progress 430 is at 25% (e.g., device 101 has so far presented “You seem to be” of audio output 440e).

In some examples, in response to detecting attention 460 of user 420 directed at pasta 408, device 101 ceases presenting audio output 440e and resumes presenting audio output 440d (e.g., from its previous progress output 430 completion of 50% or from the beginning, as described above), as illustrated in FIG. 4L, which also illustrates device 101 detecting user 420 performing a gesture with hand 424 (e.g., detecting movement and/or a new position and/or orientation of hand 424). At the point in time represented in FIG. 4L, the output progress 430 is at 80% (e.g., device has so far presented “Add the pasta now that the water” of audio output 440d) and the time elapsed 450 is at 0%.

In some examples, device 101 determines an intention of user 420 is to interrupt audio output 440d based on a combination of the state of hand 424 (e.g., an open palm “stop” gesture), the output progress 430 being above progress threshold 432b (e.g., a user is more likely to interrupt towards the end of the output progress 430), the head of user 420 not being tilted, and/or mouth 422 being closed and ceases presenting audio output 440d, as illustrated in FIG. 4L. In some examples, device 101 employs the confidence score assessment described above (e.g., the interruption confidence score is above the interruption confidence threshold despite the head of user 420 not being tilted and mouth 422 being closed) to determine whether to cease or continue presenting audio output 440d (or perform a different action). In some examples, device 101 detects user 420 performing a different gesture with hand 424 (e.g., detecting movement and/or a new position and/or orientation of hand 424), as illustrated in FIG. 4M. At the point in time represented in FIG. 4M, the output progress 430 is at 80% (e.g., device 101 merely paused audio output 440d in case user 420 wishes audio output 440d to resume) and the time elapsed 450 is at 50%. In some examples, device 101 determines an intention of user 420 is to resume the audio (or to present new audio, e.g., regarding further information about an object in focus, such as pasta 408) based on a combination of the state of hand 424 (e.g., a “thumbs up” gesture), the output progress 430 being above progress threshold 432b, the head of user 420 not being tilted, and/or mouth 422 being closed. In some examples, device 101 employs the confidence score assessment described above (e.g., a resumption confidence score is above a resumption confidence threshold) to determine whether to resume audio output 440d (and/or present new audio).

In some examples, upon determining the intention of user 420 is to resume the audio, device 101 begins presenting audio output 440f (e.g., “To ensure even, consistent cooking, you should only add the pasta when the water is boiling.”), as illustrated in FIG. 4N. In some examples, device 101 determines whether to present audio output 440f or resume audio output 440d based on the output progress 430 of audio output 440d at the point in time illustrated in FIG. 4M (e.g., when the output progress 430 of audio output 440d is equal to or greater than progress threshold 432b, device 101 presents audio output 440f). In some examples, device 101 determines whether to rephrase or otherwise repeat similar content to the previously ceased audio output (e.g., repeat similar content to audio output 440d based on a circling motion gesture performed by hand 424) or to determine further information on an object in focus (e.g., determine further information on pasta 408 based on a “thumbs-up” gesture). At the point in time represented in FIG. 4N, the output progress 430 is at 20% (e.g., device 101 has so far presented “To ensure even” of audio output 440f).

In some examples, device 101 detects user 420 performing a gesture with hand 424 (e.g., a pointing up” gesture) while attention 460 of user 420 is directed at oil 404, as illustrated in FIG. 4O. In some examples, in response to detecting user 420 performing the gesture with hand 424 (e.g., the “pointing up” gesture), device 101 presents audio output 440g, as illustrated in FIG. 4P. In some examples, device 101 determines an intention of user 420 is to request further information (e.g., further information on an object in focus, such as oil 404) based on a combination of the state of hand 424, device 101 not presenting an audio output, the head of user 420 not being tilted, and/or mouth 422 being closed. In some examples, device 101 employs the confidence score assessment described above (e.g., a further information confidence score is above a further information confidence threshold) to determine whether to present audio output 440g.

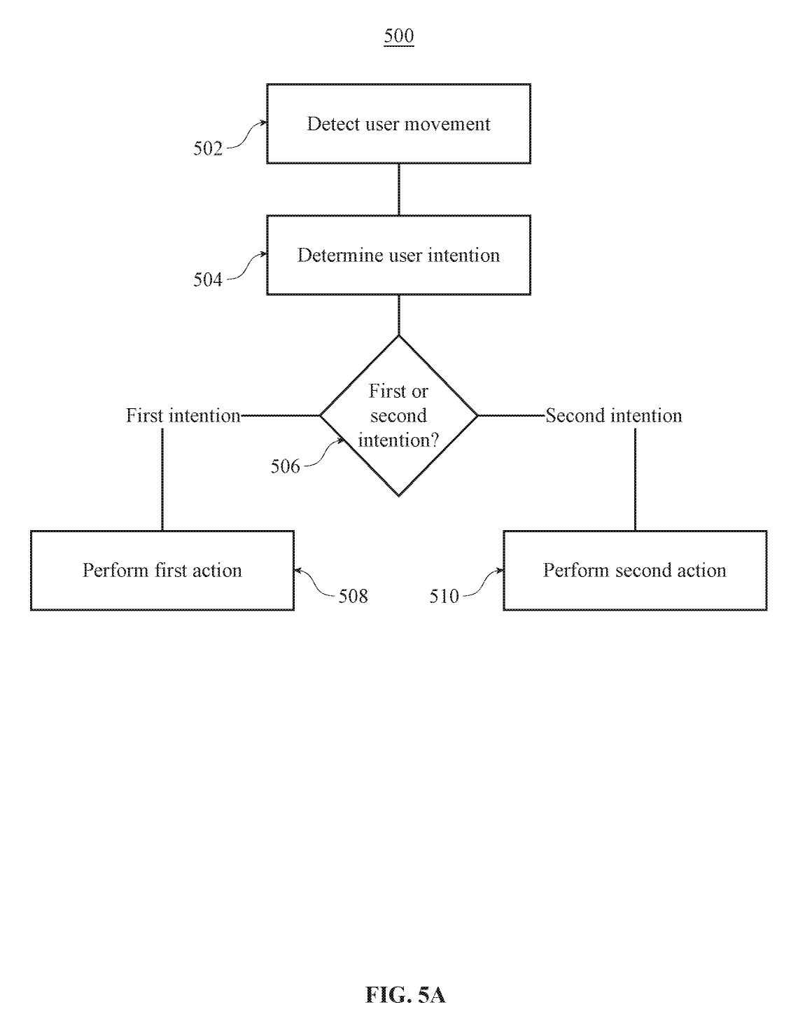

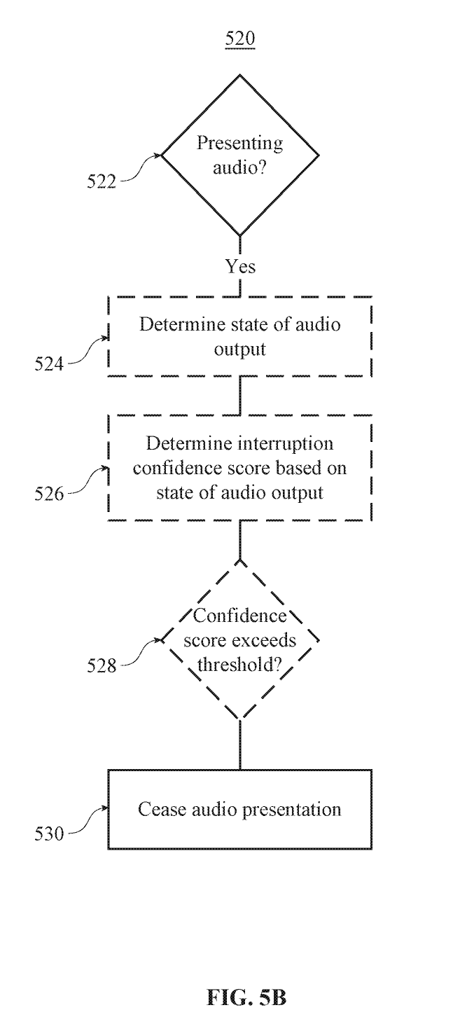

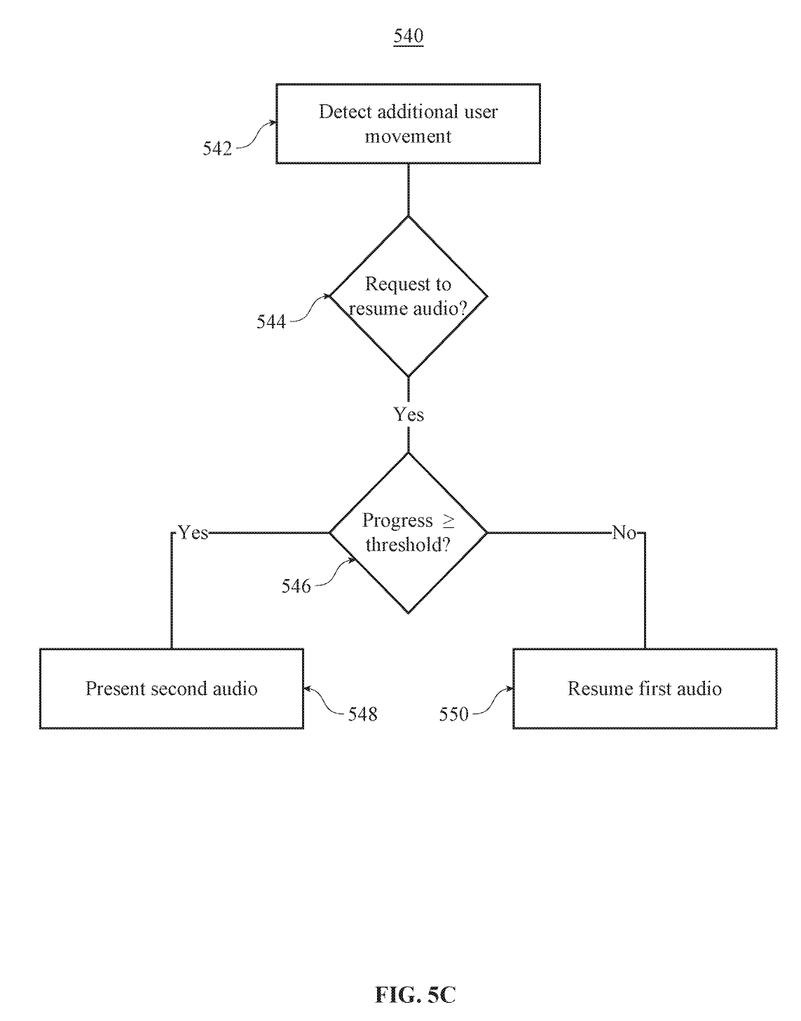

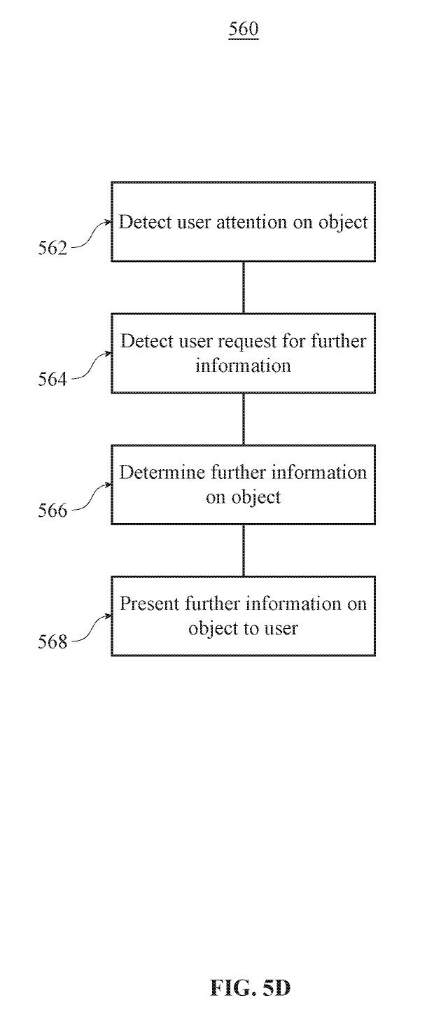

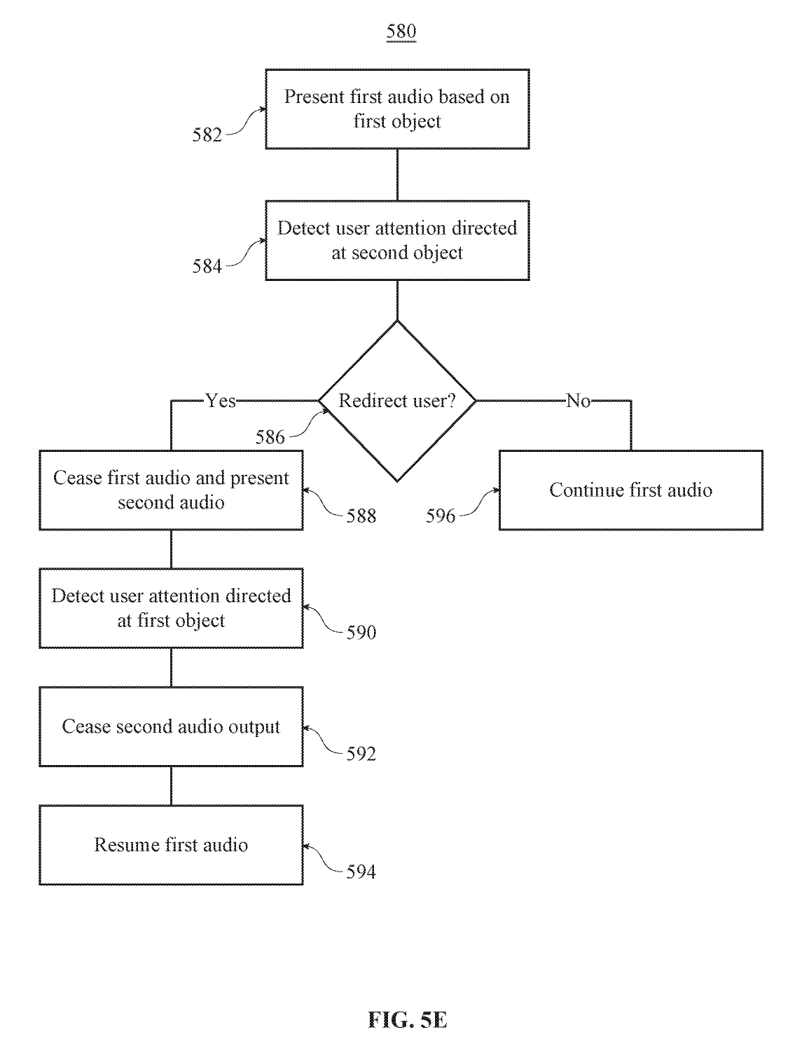

FIGS. 5A-5E illustrate flow diagrams of example processes for performing actions based on user intentions, according to some examples of the disclosure.

FIG. 5A illustrates a method 500 for detecting user movements, determining user intentions, and performing different actions based on said intentions. Method 500 optionally includes additional or fewer operations in different implementations.

In some examples, at operation 502, an electronic device (e.g., device 101, 201, 260, 300 and/or a different suitable electronic device) detects one or more movements of at least a portion of a body of a user of the electronic device (e.g., a head tilt, hand gesture, gaze shift, mouth opening, pupil dilation, and/or elevated heart rate). For example, as illustrated in FIG. 4C, device 101 detects user 420 tilting their head toward the right while presenting audio output 440a.

In some examples, the device employs one or more input devices—such as cameras, IMUs, eye-tracking sensors, and/or microphones. In some examples, device 101 detects a user movement by continuously monitoring orientation changes over a short time window to identify a build-up of tilt angle that signifies a user intention. In some examples, detecting the one or more movements includes combining data from one or more sensors to identify small and/or subtle gestures, as well as more deliberate gestures. In some examples, device 101 compiles overlapping or redundant data from multiple sensors (e.g., IMU plus image sensors) to yield a higher-confidence detection of movement. In some examples, the device calculates a magnitude of the movement (e.g., the angle of a head tilt or the speed of a hand gesture) and/or the duration of the movement to determine if it meets or exceeds one or more thresholds for subsequent analysis. In some examples, the device correlates the movement of the user with the progress of an ongoing task (e.g., the cooking steps shown in FIGS. 4A-4P) to determine whether the movement is contextually relevant.

In some examples, device 101 uses a machine-learning classifier (or a programmed classifier) trained on the personal motion signatures of the user (e.g., to filter out common fidgeting patterns that do not indicate an intention or to recognize movements that historically indicate an intention for the user). In some examples, the device uses a machine-learning classifier that processes sensor data in near-real time to generate a continuous stream of potential intentions as the user moves. In some examples, the device references historical motion patterns to reduce false positives (e.g., ignoring minor habitual tics or quick posture adjustments that do not indicate any particular user intention). In some examples, the device simultaneously detects a user head tilt and an additional sign of attention, such as a gaze shift to an object in environment 400, to create a combined “movement event.” In some examples, the device adapts its sensitivity to the user’s movements based on external conditions (e.g., noisy and/or hectic environments).

In some examples, method 500 proceeds to operation 504, where the device determines a user intention based on the detected movement, historical user data, and/or additional context. In some examples, this determination includes comparing the detected movement to known movement patterns, applying thresholds (e.g., angle of head tilt, mouth openness level), and/or leveraging a machine-learning model trained to interpret user gestures (e.g., in a specific environment, such as cooking instructions, navigation assistance, etc.). For example, as illustrated in FIG. 4C, the combination of a detected head tilt, a relatively low output progress 430 (15%), and/or an open mouth 422 led device 101 to determine user 420 was likely about to speak (and setting a high interruption confidence). As another example, as illustrated in FIGS. 4E-4F, device 101 detected a similar head tilt but observed that the output progress 430 was equal to or greater than a threshold (indicating the user might be near the end of audio output 440b) and that mouth 422 was closed, and based on this combination, device 101 determines the tilt as a non-interruption movement. As yet another example, as illustrated in FIG. 4K, when attention 460 of user 420 was directed at rice 410 instead of pasta 408, device 101 determined the intention of user 420 was to find an object associated with audio output 440d, which led device 101 to present audio output 440e.

In some examples, the device assigns a confidence score or probability to each potential user intention. For example, a head tilt optionally yields a 70% likelihood of the user intending to interrupt ongoing audio and a 30% of the user simply adjusting posture. The device then optionally selects whichever intention exceeds a respective confidence threshold (e.g., 50%, 65%, 85%, 95%, 99%, 99.9%) and/or uses further sensor data (e.g., mouth 422 openness and/or output progress 430) to refine the confidence score. In some examples, when two intentions (e.g., interrupt versus request for more information) surpass their respective thresholds, the device automatically determines which is more likely (e.g., by considering one or more contextual factors) and/or prompts the user for an input to clarify the user intention.

In some examples, the device compares the current gesture pattern (e.g., a combination of one or more movements of one or more portions of the user) against previously stored patterns specific to the user (e.g., user 420 frequently tilts their head slightly before making a comment). In some examples, the device learns from misinterpretations (e.g., user 420 quickly overrides an interruption action in FIGS. 4G-4I) by updating internal weighting for each recognized gesture in future interactions, as described in greater detail with respect to FIG. 6. In some examples, the device updates a persistent user intention profile to track how the gestures and/or movements of the user vary under different conditions (e.g., wearing thick gloves, being in a noisy environment, or feeling rushed).

In some examples, method 500 proceeds to operation 506, where the device compares the user intention determined in operation 504 against one or more criteria or thresholds to determine whether the user intention corresponds to a first intention or a second intention (or a third intention, or a fourth intention, and so on). In some examples, the one or more criteria include numerical thresholds (e.g., an interruption confidence threshold), logical conditions (e.g., mouth open plus head tilt equals “interrupt”), and/or more complex context-based rules (e.g., attention 460 of user 420 away from pasta 408 while device 101 presents audio output 440d concerning pasta 408). For example, device 101 determines in FIG. 4C that a head tilt plus mouth 422 opening while output progress 430 is below progress threshold 432a equals a high interrupt confidence. However, device 101 determines in FIG. 4E that the same head tilt while output progress 430 is above progress threshold 432a equals a low interrupt confidence.

In some examples, the device assigns labels to different user intentions. For instance, the “first intention” is optionally “interrupt” or “speak,” while the “second intention” is optionally “allow audio to continue,” “request more information,” “proceed to the next step,” or a different suitable user intention. In some examples, the device applies one or more confidence scores derived from sensor data (e.g., movement magnitude, timing, and/or the attention of the user) and compares each against a threshold. In some examples, the device maintains multiple thresholds, each corresponding to different types of first and second intentions (e.g., an interrupt threshold, a clarification threshold, or a resume threshold). In some examples, the device factors in a “time elapsed” measurement (e.g., time elapsed 450) such that when the user does not reinforce the initial signal before the time exceeds a certain threshold (e.g., 0.5 s, 1 s, 2 s, 5 s, or 10 s), the device switches from the first intention (e.g., interrupt) to the second intention (e.g., continue). In some examples, the device compares one or more intentions to determine which is more likely to be the actual user intention. For example, the device optionally applies a majority vote logic across multiple sensors or models, where each sensor reading (e.g., mouth open versus closed) casts a vote for the first intention (e.g., interrupt) or the second intention (e.g., continue), and the outcome is decided by the aggregated votes. In some examples, the device updates one or more thresholds dynamically based on contextual data (e.g., historical user behavior and/or environmental characteristics).

In some examples, method 500 proceeds to operation 508, where the device performs a first action when it determines the user intention corresponds to the first intention. For example, as illustrated in FIGS. 4C-4D, upon detecting user 420 tilting their head at only 15% output progress 430 of audio output 440a, device 101 interprets the gesture as an interruption and ceases audio output 440a. As another example, the first action optionally includes switching to a different form of presentation (e.g., switching from audio presentation to visual presentation when the user intention indicates confusion or preference for a non-audio mode). Other examples of first actions include, but are not limited to, ceasing (or pausing) ongoing audio presentation (e.g., corresponding to an intention to interrupt), terminating an ongoing audio presentation entirely (e.g., corresponding to an intention to skip a step or go to the next topic), and/or changing an ongoing audio presentation (e.g., to provide an explanation or clarification when the indication corresponds to confusion or uncertainty or to switch to presenting information on a newly detected object when the intention corresponds to a different object of interest). In some examples, ceasing the ongoing audio presentation involves pausing the audio presentation so that it is optionally resumed later. Alternatively, the device optionally fully terminates the audio presentation when the context suggests the user wants to skip the current audio presentation altogether. In some examples, the first action includes recording a last known state of the audio presentation so that the device optionally restarts the audio presentation from exactly the same point. In some examples, the device transmits a signal corresponding to the first action (e.g., a “stop instruction”) to a secondary system (e.g., a synced speaker) so that all connected devices perform the first action (e.g., cease their output) simultaneously.

In some examples, method 500 proceeds to operation 510, where the device performs a second action when it determines the user intention corresponds to the second intention. In some examples, the second action and the second intention share one or more characteristics with the first action and the first intention described above. In some examples, the second action represents the opposite or inverse of the first action (e.g., the first action is ceasing audio presentation and the second action is continuing audio presentation). In some examples, the second action corresponds to continuing the ongoing audio presentation (e.g., when the movement and/or context of the user suggest they are not about to speak or request new information)). For example, as illustrated in FIG. 4F, when user 420 tilts their head but does not open mouth 422 and the output progress 430 is at or above progress threshold 432a, the device determines the second intention is to continue listening (and the second action is device 101 continuing presenting audio output 440b until completion). Other examples of second actions include, but are not limited to, increasing the volume of an audio presentation (e.g., corresponding to an intention to hear more clearly), unmuting or unpausing previously ceased audio presentations (e.g., corresponding to an intention to continue audio presentation), repeating an audio presentation (e.g., corresponding to an intention to review past content), and/or switching to a different topic (e.g., corresponding to an intention to request further information).

FIG. 5B illustrates an example method 520 of a first action (e.g., operation 508) that corresponds to ceasing audio presentation. Method 520 optionally includes additional or fewer operations in different implementations. In some examples, operations 524, 526, and 528 are optional (e.g., when no further context is needed to determine whether to cease the audio output).

In some examples, operation 522 occurs in response to the device determining the user intention is the first intention at operation 506 of method 500. In some examples, at operation 522, the device evaluates whether it is currently presenting an audio output to the user. For example, the device optionally plays spoken instructions, prompts, music, and/or different forms of audio content (e.g., audio outputs 440a-440g) through one or more speakers (e.g., speakers 216A-216B). When the device determines that no audio is being presented, method 520 optionally terminates. Conversely, when the device determines that audio is being presented, method 520 optionally proceeds to operation 524.

In some examples, at operation 524, the device determines the state of the audio output currently being presented. In some examples, the state of the audio output refers to one or more parameters that describe the current playback context (e.g., progress, remaining duration, volume level, speed or playback rate, whether it is part of a multi-step sequence, and/or other relevant attributes of the ongoing audio output). For example, in FIG. 4C, device 101 determines that audio output 440a is at 15% output progress 430. By determining these parameters, the device refines its ability to determine whether the user intends to interrupt. For instance, a user tilting their head at 5% progress optionally indicates a stronger likelihood of interruption than the same gesture at 50% progress.

In some examples, at operation 526, the device determines an interruption confidence score based on the detected user movement and the audio state identified at operation 524. In some examples, the interruption confidence score is derived from a combination of sensor inputs (e.g., head tilt angle and/or IMU data), environmental characteristics (e.g., noisy or hectic environment), audio parameters (e.g., 5% or 50% progress), and/or other relevant parameters described herein. In some examples, a higher interruption confidence score indicates a stronger likelihood that the user wants the device to cease and/or pause the audio output, while a lower score indicates a stronger likelihood that the user movement was incidental. In some examples, the device applies a machine-learning model, a rules-based engine, or a combination of both to determine the interruption confidence score. For example, in FIG. 4C, combining output progress 430 at 15%, the head tilt, and mouth 422 being open causes electronic device 101 to compute a high interruption confidence score (e.g., 85%). Conversely, in FIG. 4E, the same head tilt at a 70% output progress 430 while mouth 422 is closed optionally yields a low interruption confidence score (e.g., 10%).

In some examples, the device weights more recent user activity (e.g., opening the mouth within the last second versus tilting the head five seconds ago) more heavily when calculating the interruption confidence score. In some examples, the device relies on a threshold-based metric (e.g., assigning points for each relevant factor, such as + 0.45 for the mouth being open, + 0.15 for the head tilt, and/or – 0.20 for 50% audio output progress). In some examples, the device incorporates user-specific data (e.g., how frequently the user interrupts audio at various progress levels) to dynamically change the interruption confidence. In some examples, the device adjusts the confidence score dynamically while the device tracks whether the user sustains a particular movement (e.g., holding a head tilt for a respective amount of time).

In some examples, at operation 528, the device compares the interruption confidence score to one or more thresholds to decide whether to proceed to operation 530 and cease audio presentation. In some examples, when the device determines that the interruption confidence score exceeds a designated threshold (e.g., 0.5, 0.65, 0.75, 0.88, 0.97, or 0.99 on a 0–1 probability scale), the device classifies the intention of the user as an interrupt intention and method 520 proceeds to operation 530. In some examples, when the device determines that the interruption confidence score does not exceed the designated threshold, the device optionally continues presenting the audio output. For example, using the example numbers described with respect to operation 526, when the confidence threshold is 75%, the high interruption confidence score of FIG. 4C (e.g., 85%) would cause method 500 to proceed to operation 530, while the low interruption score (e.g., 10%) would optionally cause method 500 to terminate.

In some examples, the device dynamically adjusts the confidence threshold based on historical user data (e.g., how quickly the user typically interrupts instructions) and/or environmental characteristics (e.g., background noise levels and/or hectic surroundings). In some examples, the device maintains separate thresholds for different intentions (e.g., different thresholds for interruptions and requests for further information). In some examples, the device maintains separate thresholds for different interruption contexts (e.g., early-progress threshold versus late-progress threshold). In some examples, the device overrides the interruption confidence threshold when a particular movement is detected (e.g., a movement tied to a strong likelihood of interruption, such as the user beginning to speak).

In some examples, at operation 530, the device ceases the ongoing audio presentation. In some examples, ceasing the audio presentation shares one or more characteristics with the first action described with respect to operation 508.

FIG. 5C illustrates an example method 540 for resuming audio output after it has been paused, interrupted, or otherwise ceased. Method 540 optionally includes additional or fewer operations in different implementations.

In some examples, at operation 542, the device detects an additional user movement following a pause or cessation of an audio output (e.g., a first audio output) (e.g., operations 508 or 530). In some examples, the additional user movement shares one or more characteristics with the plurality of user movements described herein. For example, in FIG. 4M, after a cessation of audio output 440d, device 101 detects a gesture performed by hand 424 (e.g., the “thumbs-up” gesture). In some examples, the device accounts for the time elapsed since the audio output has been paused (e.g., to determine whether the audio output is merely resumed, whether to present a recap or a restart of the audio output, or whether to present a new audio output).

In some examples, at operation 544, the device evaluates the additional user movement to determine whether it signifies (e.g., the user movement constitutes a specific gesture, or a user intention is determined based on the user movement) a request or intention to resume audio that was previously ceased. In some examples, determining whether the additional user movement signifies a request or intention to resume audio shares one or more characteristics with determining the user intention described with respect to operation 504. For example, in FIG. 4M, device 101 determines the “thumbs-up” gesture performed by hand 424 corresponds to a request to resume an audio output (e.g., audio output 440d). In some examples, the device analyzes how quickly the user performs the additional movement after the cessation of the audio output (e.g., an immediate gesture is a stronger indicator of a user desire to resume audio output than a later gesture).

In some examples, at operation 546, the device compares the progress of the previously ceased audio output (e.g., the first audio output) to one or more thresholds (e.g., an audio output completion threshold). For instance, when the first audio output was 80% complete at the time it was ceased, and the device defines a threshold of 75% completion (e.g., the scenario illustrated in FIG. 4L), the device optionally determines that the user has heard most of the relevant content from the first audio output already and presents the user with new or summarized information. Conversely, when the first audio output was 5% complete at the time it was ceased (e.g., the scenario illustrated in FIGS. 4H-4I), the device optionally determines that the user has not heard enough of the first audio output, thus resuming the presentation of the first audio output.

In some examples, the device adapts the threshold dynamically based on an analysis of the previously ceased audio output (e.g., when a more relevant portion of the audio output occurs earlier in the audio output, the threshold is optionally lower, whereas when the more relevant portion of the audio output occurs towards the end of the audio output, the threshold is optionally higher). In some examples, the device adapts the threshold dynamically based on whether the user has historically requested audio output restarts after hearing more than a certain portion of the content (and/or whether the user has historically requested audio output cessation or termination after hearing more than a certain portion of the content). In some examples, the device adapts the threshold dynamically based on one or more contextual factors (e.g., the complexity of the audio output, whether the audio output includes critical and/or relevant information, user preference, and/or historical user interactions). In some examples, when the device determines that the audio progress is equal to or greater than the threshold, the device proceeds to operation 548, whereas when the audio progress is less than the threshold, the device proceeds to operation 550.

In some examples, at operation 548, the device presents a second audio. In some examples, the second audio is entirely new content (e.g., new instructions), a summary of the first audio output, or additional information or guidance specific to the context of the user (e.g., the environment of the user, the first audio output, and/or other contextual factors described herein). For example, in FIG. 4N, when user 420 attempts to resume audio after device 101 ceased (or paused) audio output 440d at a high completion point (e.g., 80% output progress 430), device 101 presents audio output 440f, rather than resuming audio output 440d. In some examples, when device 101 detects that pot 402 is already boiling or that attention 460 of user 420 is directed at a different ingredient, outputting audio output 440f (e.g., “Consider stirring the contents of the pot”) aligns better with the immediate needs of user 420 than replaying or resuming audio output 440d. In some examples, the device determines the content of the second audio output based on one or more contextual factors of one or more objects that have the attention of the user.

In some examples, at operation 550, the device resumes the first audio output from its previously halted point. In some examples, resuming the first audio involves presenting the first audio output from precisely where the audio output stopped, rewinding slightly for additional context, and/or replaying the last several seconds of content (e.g., 1 s, 2 s, 3 s, 5 s, or 10 s,) to refresh the memory of the user. For example, in FIG. 4I, device 101 detects user 420 attempting to resume audio output 440c (e.g., by determining the first intention was not an intention to interrupt after the time elapsed 450 exceeds the respective threshold) after 5% completion of the output progress 430, which causes electronic device 101 to resume audio output 440c.

FIG. 5D illustrates an example method 560 for determining and presenting further information on an object in the environment of the user. Method 560 optionally includes additional or fewer operations in different implementations.

In some examples, at operation 562, the device detects that the attention of the user (e.g., determined via the gaze of the user, gestures, and/or other non-verbal cues) is directed at a respective object within the environment of the user. In some examples, the attention of the user is detected via one or more of the methods described herein. For example, in FIG. 4O, device 101 detects attention 460 of user 420 is directed at oil 404. In some examples, the device factors in a length of time that the attention of the user has been on the respective object.

In some examples, at operation 564, the device detects that the user explicitly or implicitly requests additional information about the respective object. While operation 562 focuses on recognizing user attention to an object, operation 564 involves determining that the user intends to learn more (e.g., by speaking a command, performing a specific gesture (e.g., the “pointing up” sign illustrated in FIG. 4O), or combining multiple cues (e.g., a raised hand plus prolonged gaze). In some examples, the device evaluates whether the detected user request for additional information corresponds to “explain,” “compare,” or another type of request for further details regarding the object currently in focus.

In some examples, at operation 566, the device identifies, retrieves, generates, and/or otherwise determines further information related to the object that the user attention is on and about which the user has requested further information. In some examples, determining further information involves querying a local database (e.g., stored recipes, dictionaries, and/or object metadata), accessing external resources (e.g., a cloud server with detailed specifications), and/or leveraging built-in knowledge modules (e.g., machine-learning models trained on object recognition). In some examples, the device extracts information relevant to a current context of the user (e.g., cooking advice, safety instructions, and/or usage tips). For example, in FIGS. 4O-4P, device 101 determines further information on oil 404 (e.g., optionally relevant to the current context of user 420—cooking). In some examples, the device references historical user interactions (e.g., scanned grocery receipts, favorited recipes, and/or a diet of the user) to tailor the further information (e.g., user 420 often cooks Mediterranean food, so device 101 determines further information on oil 404 related to Mediterranean food).

In some examples, at operation 568, the device presents the further information about the object. In some examples, presenting the further information includes displaying text and/or images (e.g., via display 120), generating an audio output (e.g., through speakers 216A-216B), or providing a combination of both. In some examples, the presentation method is based on environmental conditions (e.g., noisy or hectic environments), user preferences (e.g., preferring visual over audio presentation), and/or situational context (e.g., the user is listening to music and would not like interruptions). For example, in FIG. 4P, device 101 presents audio output 440g to user 420 corresponding to further information about oil 404.

FIG. 5E illustrates an example method 580 for redirecting the user (e.g., from one object or topic to another) based on one or more contextual factors (e.g., a change in the attention of the user and/or environmental triggers). Method 580 optionally includes additional or fewer operations in different implementations.

In some examples, at operation 582, the device presents a first audio output (e.g., via speakers 216A-216B) related to a first object (or topic) (e.g., cooking instructions for pasta, instructions about a particular machine part, or another context-specific audio). For example, in FIG. 4J, device 101 presents audio output 440d associated with pasta 408. In some examples, the device presents a visual representation (e.g., a textual prompt) of the first audio output simultaneously with or instead of presenting the first audio output.

In some examples, at operation 584, the device detects that the attention of the user is directed at a second object, different from the first object (e.g., the attention of the user has shifted from the first object to the second object or was never directed at the first object). For example, in FIG. 4J, device 101 detects attention 460 of user 420 on rice 410 while audio output 440d is associated pasta 408. In some examples, detecting the attention of the user is directed at the second object includes detecting a speech input from the user that references the second object. In some examples, the device waits for a threshold amount of time (e.g., 0.5 s, 1 s, 2 s, 5 s, or 10 s) before concluding that the attention of the user has genuinely shifted.

In some examples, at operation 586, the device evaluates whether the user attention on the second object is strong or relevant enough to redirect the user back to the first object. For example, in FIGS. 4J-4K, device 101 determines the user attention on rice 410 (e.g., attention 460 of user 420) is strong or relevant enough to begin the process to redirect the user back to the first object. In some examples, the evaluation is based on one or more factors, including, but not limited to, a duration of the gaze of the user on the second object, a proximity and/or posture of the user relative to the second object, an ongoing output progress level of the first audio, sensor data indicating possible confusion or frustration on the part of the user (e.g., a determined user intention), speech detection (e.g., the user verbally referencing the second object), a relevance or importance of the second object to the current context, historical user preferences for switching focus under similar conditions, user gestures (e.g., pointing, nodding, and/or head tilts towards the second object), and/or environmental triggers.

In some examples, at operation 588, the device ceases (or pauses) the first audio output and presents a second audio output (e.g., specifically aimed at redirecting the attention of the user from the second object back to the first object. For example, in FIG. 4K, device 101 ceases audio output 440d and presents audio output 440e (e.g., containing instructions to redirect attention 460 of user 420 from rice 410 to pasta 408). In some examples, the device adapts one or more characteristics of the second audio output (e.g., tone, pitch, volume, length, and/or urgency) based on a determination of how critical or urgent it is for the user to return attention to the first object. For instance, the device optionally presents an urgent audio output when the attention of the user is directed elsewhere while pot 402 is boiling and overflowing.

In some examples, at operation 590, the device detects that the attention of the user has returned to the first object. For example, in FIG. 4L, device 101 detects that attention 460 of user 420 is directed at pasta 408 (and no longer directed at rice 410). In some examples, the device confirms that the user has genuinely returned their attention to the first object by waiting for a threshold amount of time and/or a verifying gesture (e.g., a nod toward pasta 408 or a speech input).

In some examples, at operation 592, the device ceases the second audio output (e.g., in response to detecting that the user has returned their attention to the first object). For example, in FIG. 4L, device 101 ceases audio output 440e (e.g., in response to detecting attention 460 of user 420 directed at pasta 408). In some examples, the device ceases the second audio output before the output progress is 100% complete (e.g., as soon as the device detects the user direct their attention to the first object).

In some examples, at operation 594, the device resumes the first audio. For example, in FIG. 4L, device 101 resumes presenting audio output 440d (e.g., from a 50% output progress 430, as it was in FIG. 4J when device 101 ceased audio output 440d). In some examples, resuming presenting audio output 440d shares one or more characteristics with one or more instances of resuming audio output (e.g., operation 550) described in herein.

In some examples, at operation 596, the device continues presenting the first audio (e.g., does not interrupt the first audio) upon determining (at operation 586) that the shift in attention of the user detected at operation 584 is either negligible, temporary, or otherwise not compelling enough to warrant a redirection (e.g., the user’s gaze and/or movement toward the second object is insufficiently relevant and/or intentional). For example, in FIG. 4J, when device 101 determines that the shift in attention 460 of user 420 to rice 410 is negligible, device 101 continues presenting audio output 440d (e.g., without ceasing audio output 440d and presenting audio output 440e, as in FIG. 4K).

It is understood that methods 500, 520, 540, 560, and 580 are examples and that more, fewer, and/or different operations can be performed in the same or in a different order. Additionally, the operations in methods 500, 520, 540, 560, and 580 described above are, optionally, implemented by running one or more functional modules in an information processing apparatus such as general-purpose processors (e.g., as described with respect to FIGS. 2A-2B) or application specific chips, and/or by other components of FIGS. 2A-2B.

FIG. 6 illustrates an input/output diagram of a model for determining a user intention based on a movement of a portion of a user, according to some examples of the disclosure. In some examples, a user intention model 600 (or model 600) receives training data 602, movement data 604, and/or context data 606 as inputs, and produces a user intention 608 as the output.

In some examples, model 600 is a computational or algorithmic construct configured to interpret user movements in light of various contextual factors and training data to produce user intention 608 (e.g., “interrupt,” “resume,” “request information,” “redirect,” or another determinable intention). In some examples, model 600 runs locally on device 101 (e.g., a wearable device, as described in FIGS. 1-4) or operate on a remote server.

In some examples, model 600 is a rule-based or heuristic engine that uses if-then rules (e.g., “If head tilt angle > X° and audio progress < Y%, interpret as interruption”). In some examples, model 600 incorporates one or more threshold checks and/or confidence scoring per rule.

In some examples, model 600 is a machine-learning model that employs supervised learning (e.g., neural networks (e.g., Multilayer Perceptrons (MLPs), Convolutional Neural Networks (CNNs), or Recurrent Neural Networks (RNNs)), reinforcement learning (e.g., training a policy that maximizes correct interpretation rewards), semi-supervised learning (e.g., leveraging unlabeled motion data alongside smaller labeled sets), transfer learning (e.g., adapting a model pre-trained on generic gesture data to a specific user environment), meta-learning (e.g., training a “model of models” that adapts to new gestures), and/or generative approaches (e.g., variational autoencoders or generative adversarial networks to synthesize plausible motion patterns). In some examples, model 600 supports unsupervised learning (e.g., clustering user gestures to discover new categories of movements without explicit labels) or gradient-boosted trees. In some examples, the one or more algorithms of model 600 incorporate time-series data using long short-term memory (LSTM) or Transformer-based architectures to capture movement sequence patterns, or a combination of these techniques. In some examples, model 600 is a combination of multiple sub-models (e.g., one specialized in “interrupt detection,” another in “object focus,” another in “confusion detection,” and other sub-models specialized in one or more aspects concerning the determination of user intentions described herein). In some examples, model 600 combines heuristics (e.g., for strong known patterns) with ML-based classification (e.g., for uncertain and/or subtle gestures).

In some examples, training data 602 refers to historical and/or synthesized data used to train, update, and/or refine one or more parameters and/or logic of model 600. In some examples, training data 602 includes user-specific data (e.g., past gestures and/or movements from the user, and optionally the correct or final interpreted intentions corresponding to said past gestures and/or movements), generic datasets (e.g., one or more datasets of gestures from many users, covering cultural, personal, and/or situational variations), and/or user feedback and overrides (e.g., corrections from the user—such as at times the device misinterpreted a respective gesture—that help model 600 learn and reduce future errors). In some examples, training data 602 is annotated with actual user intentions (e.g., supervised learning) or remains unannotated (e.g., unsupervised learning). In some examples, the device aggregates data from multiple devices across various users and includes the aggregated data in training data 602. In some examples, the device prompts the user (e.g., occasionally) to label ambiguous gestures (e.g., associated with low-confidence scores) to transform unlabeled motion data into new ground-truth entries in training data 602.

In some examples, the device (or a server) trains model 600 on one or more comprehensive datasets (e.g., movement recordings, user override logs, context-enriched scenarios, and other data that is part of training data 602) offline during the manufacturing process of the device. In some examples, as the user interacts with the device, each correct and/or incorrect interpretation becomes new training data 602. In some examples, model 600 refines thresholds and/or network weights to reduce future misclassifications for the specific user of the device (e.g., user 420 of device 101) to recognize personal quirks and/or cultural gestures (e.g., a habit of lightly tilting their head before speaking). In some examples, the device applies a reinforcement learning framework in which a reward is assigned whenever model 600 accurately predicts a user’s intention. In some examples, the device initializes model 600 with weights learned from a generic gesture dataset, and then adjusts those weights using movement data 604 associated with the user of the device. In some examples, when the device detects the user consistently exhibiting culturally distinct gestures, the device dynamically updates its knowledge (e.g., training data 602) to include knowledge specialized in that cultural context (e.g., by transferring knowledge from an outside specialized source).

In some examples, movement data 604 refers to sensor data that captures physical gestures and/or motions from the user (e.g., captured by one or more cameras, IMUs, and/or eye-tracking sensors). In some examples, movement data 604 includes raw sensor data (e.g., IMU acceleration and/or camera frames) and/or pre-processed gestures (e.g., classifier outputs like “nod,” “shake,” or “hand raise”).

In some examples, context data 606 refers to information about environmental, temporal, task, and/or user conditions that optionally shape how user movements should be interpreted (e.g., how movement data 604 should be interpreted). Some examples of context data 606 include audio state (e.g., whether device 101 is presenting audio at 5% output progress or 90% output progress), object focus (e.g., which object currently has the attention of user 420), user profile (e.g., preferences or constraints input by user 420), and/or environmental conditions (e.g., noise level, lighting conditions, and/or known location- or scenario- based triggers (e.g., generic triggers in a kitchen environment or during a cooking process)).

In some examples, at run time, model 600 obtains movement data 604 (either raw or pre-processed) and analyzes relevant context data 606. In some examples, at run time, training data 602 is optionally not directly input into the inference operation (e.g., the determination of user intention 608) but is implicitly reflected in the internal parameters of model 600 (unless real-time on-device training is active, in which case new training data 602 is input at run time). In some examples, model 600 calculates an internal representation or feature set, and optionally computes a confidence score for each possible intention (e.g., interrupt, resume, request information, confusion, or another suitable intention). In some examples, model 600 uses a purely heuristic approach, model 600 matches the conditions (e.g., “IF head tilt angle > threshold AND context = early audio interrupt”). In some examples, the device obtains a final or top-ranked intention (e.g., user intention 608), which is optionally represented as a single label (e.g., “speak”) or multiple labels (e.g., with multiple associated probabilities). In some examples, model 600 outputs a confidence score and/or other metadata (e.g., “interrupt: 85% confidence, resume: 15% confidence”). In some examples, the device (e.g., device 101) feeds user intention 608 into subsequent logic (e.g., operation 506 of method 500 to decide whether the intention corresponds to a “first intention” or a “second intention”).

In some examples, when movement data 604 is incomplete and/or contradictory, model 600 produces a “low-confidence” intention or a “no intention detected” state (e.g., optionally prompting the device to wait or request more input). In some examples, when movement data 604 and context data 606 contain conflicting data (e.g., the user is near the middle of an output but the movement suggests an interrupt), model 600 yields multiple partial intentions and prompts the device to ask for clarification (e.g., from additional data or from the user).

As an illustrative example, while a user is cooking pasta and a device is presenting an audio output, the device detects a quick head tilt and the user’s mouth opening when an output progress of the audio output is 10%. In response, a neural net (e.g., model 600) that was pre-trained on thousands of cooking sessions interprets the combination of early audio progress + tilt + mouth open “User intention to interrupt.” As a result, the device ceases the audio output and waits for the user to speak or perform a gesture.

FIGS. 7A-7C illustrate an example of a first electronic device performing an action based on a user intention determined based on an input detected by a second electronic device, according to some examples of the disclosure.

FIG. 7A illustrates electronic device 700a and electronic device 700b in communication with each other (e.g., via communication circuitry 222A-222B), operated by user 710a and user 710b, respectively. In some examples, devices 700a-700b share one or more characteristics with the one or more devices (e.g., device 101, device 201, device 260, and/or device 300) described herein. In some examples, as in FIG. 7A, electronic device 700a presents audio output 720 (e.g., via speakers 216A-216B). In some examples, electronic devices 700a-700b use one or more sensors (e.g., image sensors 114a-114c, infrared sensors, and/or other sensors capable of detecting motion) to detect user motions or gestures within their respective fields of view 730a-730b.

FIG. 7B illustrates a subsequent moment (as illustrated by the output progress 722 of audio output 720 increasing from 20% to 50%) in which device 700b detects a movement of a portion of the body of user 710a (e.g., user 710a opening their mouth 712a and/or a different gesture) within field of view 730b. In some examples, detecting the movement of the portion of the body of user 710a shares one or more characteristics with the one or more examples of detecting a movement of a portion of the body of a user described herein. In some examples, upon detecting the movement of the portion of the body of user 710a (e.g., mouth 712a opening), device 700b transmits a corresponding signal (e.g., a movement indication, an intention confidence score, and/or other relevant data) to electronic device 700a.

In some examples, upon receiving the movement-related signal from electronic device 700b, electronic device 700a determines that the movement of user 710a indicates an intention to interrupt audio output 720, as illustrated in FIG. 7C. In some examples, electronic device 700a (and/or electronic device 700b) analyze one or more contextual factors (e.g., output progress 722 or whether user 710a and user 710b were just having a conversation) when determining the intention of user 710a. In some examples, determining the intention of user 710a shares one or more characteristics with the one or more examples of determining the intention of a user described herein. In some examples, in response to determining the intention to interrupt of user 710a based on the signal transmitted by electronic device 700b, electronic device 700a ceases audio output 720. In some examples, ceasing audio output 720 shares one or more characteristics with the one or more examples of ceasing (or pausing) audio output described herein.

Therefore, according to the above, some examples of the disclosure are directed to a method performed at a first computer system in communication with one or more input devices. In some examples, the method includes detecting, via the one or more input devices, a first movement of a first portion of a user of the first computer system. In some examples, the method includes determining a first user intention based on the first movement of the first portion of the user. In some examples, in response to determining the first user intention and in accordance with a determination that the first user intention corresponds to a first intention, the method includes performing a first action. In some examples, in response to determining the first user intention and in accordance with a determination that the first user intention corresponds to a second intention, different from the first intention, the method includes performing a second action, different from the first action.

In some examples, the first intention corresponds to a user intention to interrupt a first audio output that is being presented by the first computer system and the first action corresponds to ceasing the first audio output.

In some examples, determining the first user intention includes determining a state of the first audio output at a respective time corresponding to the detecting of the first movement of the first portion of the user. In some examples, determining the first user intention includes determining a confidence score of user interruption based on the state of the first audio output at the respective time, wherein the user intention corresponds to the first intention when the confidence score of user interruption exceeds a respective threshold.

In some examples, the first movement of the first portion of the user is detected via at least one of an inertial measurement unit, an inward-facing camera, or an outward-facing camera.

In some examples determining the first user intention includes providing data associated with the first movement of the first portion of the user to a model. In some examples, determining the first user intention includes receiving, from the model, an output indicating the first user intention based on the data associated with the first movement.

In some examples, the model is trained using historical interaction data corresponding to one or more previous interactions of the user with the first computer system.

In some examples, the method includes, during the detecting of the first movement of the first portion of the user, detecting, via the one or more input devices, an attention of the user directed to a first object. In some examples, the first intention corresponds to a user request for information about the first object and the first action corresponds to presenting, via one or more output devices, the information about the first object to the user.

In some examples, the detecting the attention of the user directed to the first object includes detecting a gaze of the user directed to the first object.

In some examples, the first intention corresponds to a user request to stop a first audio output that is being presented by the first computer system and the first action corresponds to ceasing the first audio output. In some examples, the second intention corresponds to a user request to continue the first audio output that is being presented by the first computer system, and wherein the second action corresponds to continuing the first audio output.

In some examples, after ceasing presentation of the first audio output, the method includes detecting, via the one or more input devices, a movement of a portion of the user of the first computer system. In some examples, after ceasing presentation of the first audio output, the method includes determining the movement of the portion of the user corresponds to a request to resume audio output. In some examples, in response to determining the second movement of the first portion of the user or the first movement of the second portion of the user corresponds to the request to resume audio output and in accordance with a determination that an output completion of the first audio output does not exceed a respective threshold, the method includes resuming outputting, via the one or more output devices, the first audio output. In some examples, in response to determining the second movement of the first portion of the user or the first movement of the second portion of the user corresponds to the request to resume audio output and in accordance with a determination that the output completion of the first audio output exceeds the respective threshold, the method includes outputting, via the one or more output devices, a second audio output.

In some examples, outputting, via the one or more output devices, the second audio output includes detecting, via the one or more input devices, an attention of the user is directed to a first object. In some examples, outputting, via the one or more output devices, the second audio output includes determining information about the first object. In some examples, outputting, via the one or more output devices, the second audio output includes outputting, via the one or more output devices, the information about the first object.

In some examples, determining the first user intention includes detecting, via the one or more input devices, a first movement of a second portion of the user of the first computer system. In some examples, determining the first user intention includes determining the first user intention based on the first movement of the first portion of the user and the first movement of the second portion of the user.

In some examples, determining the first user intention includes determining a magnitude of movement of the first movement of the first portion of the user. In some examples, the determination that the user intention corresponds to the first intention includes determining the magnitude of movement of the first movement of the first portion of the user exceeds a respective threshold. In some examples, the determination that the user intention corresponds to the second intention includes determining the magnitude of movement of the first movement of the first portion of the user does not exceed the respective threshold.

In some examples, the first computer system is a wearable device.

In some examples, determining the first user intention includes, while the first computer system is in communication with a second computer system, receiving, via the one or more input devices, an indication from the second computer system corresponding to the first movement of the first portion of the user of the first computer system. In some examples, determining the first user intention includes, while the first computer system is in communication with a second computer system, determining the first user intention based on a comparison between the first movement of the first portion of the user and the indication received from the second computer system corresponding to the first movement of the first portion of the user.

In some examples, while the first computer system is in communication with a second computer system, the method includes detecting, via the one or more input devices, a first movement of a first portion of a user of the second computer system. In some examples, while the first computer system is in communication with a second computer system, the method includes transmitting, via one or more output devices, a signal to the second computer system corresponding to the first movement of the first portion of the user of the second computer system.

In some examples, while the first computer system is outputting, via one or more output devices, a first audio output corresponding to a first object, the method includes detecting an attention of the user directed at a second object, different from the first object. In some examples, in response to detecting the attention of the user directed at the second object and in accordance with a determination that the attention of the user directed at the second object satisfies one or more criteria, the method includes ceasing to output, via the one or more output devices, the first audio output and outputting, via the one or more output devices, a second audio output corresponding to instructions to redirect the user to the first object. In some examples, in response to detecting the attention of the user directed at the second object and in accordance with a determination that the attention of the user directed at the second object does not satisfy the one or more criteria, the method includes continuing to output, via the one or more output devices, the first audio output.

In some examples, after outputting, via the one or more output devices, at least a portion of the second audio output, the method includes detecting the attention of the user directed at the first object. In some examples, in response to detecting the attention of the user directed at the first object, the method includes ceasing to output, via the one or more output devices, the second audio output and resuming to output, via the one or more output devices, the first audio output.

Some examples of the disclosure are directed to an electronic device, comprising: one or more processors; memory; and one or more programs stored in the memory and configured to be executed by the one or more processors, the one or more programs including instructions for performing any of the above methods.

Some examples of the disclosure are directed to a non-transitory computer readable storage medium storing one or more programs, the one or more programs comprising instructions, which when executed by one or more processors of an electronic device, cause the electronic device to perform any of the above methods.

Some examples of the disclosure are directed to an electronic device, comprising one or more processors, memory, and means for performing any of the above methods.

Some examples of the disclosure are directed to an information processing apparatus for use in an electronic device, the information processing apparatus comprising means for performing any of the above methods.

The present disclosure contemplates that in some examples, the data utilized can include personal information data that uniquely identifies or can be used to contact or locate a specific person. Such personal information data can include demographic data, content consumption activity, location-based data, telephone numbers, email addresses, twitter ID's, home addresses, data or records relating to a user’s health or level of fitness (e.g., vital signs measurements, medication information, exercise information), date of birth, or any other identifying or personal information. Specifically, as described herein, one aspect of the present disclosure is tracking a user’s biometric data.

The present disclosure recognizes that the use of such personal information data, in the present technology, can be used to the benefit of users. For example, personal information data is optionally used to improve the detection and interpretation of user movements and associated user intentions. In some examples, historical movement data, user-specific gesture patterns, and/or contextual interaction data are used to refine the determination of user intentions based on detected movements (e.g., head tilts, gaze shifts, or hand gestures), thereby improving the accuracy and responsiveness of device actions (e.g., interrupting, resuming, or modifying output) in accordance with the user’s behavior.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the US, collection of or access to certain health data can be governed by federal and/or state laws, such as the Health Insurance Portability and Accountability Act (HIPAA); whereas health data in other countries can be subject to other regulations and policies and should be handled accordingly. Hence different privacy practices should be maintained for different personal data types in each country.

Despite the foregoing, the present disclosure also contemplates examples in which users selectively block the use of, or access to, personal information data. That is, the present disclosure contemplates that hardware and/or software elements can be provided to prevent or block access to such personal information data. For example, the present technology can be configured to allow users to select to “opt in” or “opt out” of participation in the collection of personal information data during registration for services or anytime thereafter. In another example, users can select not to enable recording of personal information data in a specific application (e.g., first application and/or second application). In addition to providing “opt in” and “opt out” options, the present disclosure contemplates providing notifications relating to the access or use of personal information. For instance, a user can be notified upon initiating collection that their personal information data will be accessed and then reminded again just before personal information data is accessed by the one or more devices.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user’s privacy. De-identification can be facilitated, when appropriate, by removing specific identifiers (e.g., date of birth, etc.), controlling the amount or specificity of data stored (e.g., collecting location data a city level rather than at an address level), controlling how data is stored (e.g., aggregating data across users), and/or other methods.

The foregoing description, for purpose of explanation, has been described with reference to specific examples. However, the illustrative descriptions above are not intended to be exhaustive or to limit the disclosure to the precise forms disclosed. Many modifications and variations are possible in view of the above teachings. The examples were chosen and described in order to best explain the principles of the disclosure and its practical applications, to thereby enable others skilled in the art to best use the disclosure and various described examples with various modifications as are suited to the particular use contemplated.

What is claimed is:

1. A method comprising:
at a first computer system in communication with one or more input devices and one or more output devices:
while the first computer system is presenting, via the one or more output devices, a first audio output:
detecting, via the one or more input devices, a first movement of a first portion of a user of the first computer system;
determining a first user intention based on the first movement of the first portion of the user; and
in response to determining the first user intention:
in accordance with a determination that the first user intention corresponds to an intention of the user to speak, performing a first action, including ceasing the first audio output; and
in accordance with a determination that the first user intention corresponds to a second intention, different from the intention of the user to speak, performing a second action, different from the first action.

2. The method of claim 1, wherein the intention of the user to speak corresponds to a user intention to interrupt the first audio output that is being presented by the first computer system.

3. The method of claim 2, wherein determining the first user intention includes:
determining a state of the first audio output at a respective time corresponding to the detecting of the first movement of the first portion of the user; and
determining a confidence score of user interruption based on the state of the first audio output at the respective time, wherein the first user intention corresponds to the intention of the user to speak when the confidence score of user interruption exceeds a respective threshold.

4. The method of claim 1, wherein the first movement of the first portion of the user is detected via at least one of an inertial measurement unit, an inward-facing camera, or an outward-facing camera.

5. The method of claim 1, wherein determining the first user intention includes:
providing data associated with the first movement of the first portion of the user to a model; and
receiving, from the model, an output indicating the first user intention based on the data associated with the first movement.

6. The method of claim 5, wherein the model is trained using historical interaction data corresponding to one or more previous interactions of the user with the first computer system.

7. The method of claim 1, further comprising:
during the detecting of the first movement of the first portion of the user, detecting, via the one or more input devices, an attention of the user directed to a first object, wherein the second intention corresponds to a user request for information about the first object and the second action corresponds to presenting, via one or more output devices, the information about the first object to the user.

8. The method of claim 7, wherein the detecting the attention of the user directed to the first object includes detecting a gaze of the user directed to the first object.

9. The method of claim 1, wherein the second intention corresponds to a user request to continue the first audio output that is being presented by the first computer system, and wherein the second action corresponds to continuing the first audio output via the one or more output devices.

10. The method of claim 9, further comprising:
in accordance with the determination that the first user intention corresponds to the user intention to speak:
after ceasing presentation of the first audio output, detecting, via the one or more input devices, a movement of a portion of the user of the first computer system; and
in response to detecting the movement of the portion of the user:
in accordance with a determination that the movement of the portion of the user corresponds to a request to resume audio output and with a determination that an output completion of the first audio output does not exceed a respective threshold, resuming outputting, via the one or more output devices, the first audio output, and
in accordance with the determination that the movement of the portion of the user corresponds to a request to resume audio output and with a determination that the output completion of the first audio output exceeds the respective threshold, outputting, via the one or more output devices, a second audio output; and
in accordance with a determination that the movement of the portion of the user does not correspond to the request to resume audio output, forgoing outputting the first audio output and the second audio output.

11. The method of claim 10, wherein outputting, via the one or more output devices, the second audio output includes:
detecting, via the one or more input devices, an attention of the user is directed to a first object;
determining information about the first object; and
outputting, via the one or more output devices, the information about the first object.

12. The method of claim 1, wherein determining the first user intention further includes:
detecting, via the one or more input devices, a first movement of a second portion of the user of the first computer system; and
determining the first user intention based on the first movement of the first portion of the user and the first movement of the second portion of the user.

13. The method of claim 1, wherein:
determining the first user intention includes determining a magnitude of movement of the first movement of the first portion of the user,
the determination that the first user intention corresponds to the user intention to speak includes determining the magnitude of movement of the first movement of the first portion of the user meets or exceeds a respective threshold, and
the determination that the user intention corresponds to the second intention includes determining the magnitude of movement of the first movement of the first portion of the user does not exceed the respective threshold.

14. The method of claim 1, wherein the first computer system is a wearable device.

15. The method of claim 1, wherein determining the first user intention further includes:
while the first computer system is in communication with a second computer system:
receiving, via the one or more input devices, an indication from the second computer system corresponding to the first movement of the first portion of the user of the first computer system; and
determining the first user intention based on a comparison between the first movement of the first portion of the user and the indication received from the second computer system corresponding to the first movement of the first portion of the user.

16. The method of claim 1, further comprising:
while the first computer system is in communication with a second computer system:
detecting, via the one or more input devices, a first movement of a first portion of a user of the second computer system; and
transmitting, via the one or more output devices, a signal to the second computer system corresponding to the first movement of the first portion of the user of the second computer system.

17. The method of claim 1, further comprising:
while the first computer system is outputting, via the one or more output devices, a second audio output corresponding to a first object:
detecting an attention of the user directed at a second object, different from the first object; and
in response to detecting the attention of the user directed at the second object:
in accordance with a determination that the attention of the user directed at the second object satisfies one or more criteria, ceasing to output, via the one or more output devices, the second audio output and outputting, via the one or more output devices, a third audio output corresponding to instructions to redirect the user to the first object; and
in accordance with a determination that the attention of the user directed at the second object does not satisfy the one or more criteria, continuing to output, via the one or more output devices, the second audio output.

18. The method of claim 17, further comprising:
after outputting, via the one or more output devices, at least a portion of the third audio output, detecting the attention of the user directed at the first object; and
in response to detecting the attention of the user directed at the first object, ceasing to output, via the one or more output devices, the third audio output and resuming to output, via the one or more output devices, the second audio output.

19. A first computer system comprising:
one or more processors;
one or more input devices;
one or more output devices;
memory; and
one or more programs stored in the memory and configured to be executed by the one or more processors, the one or more programs including instructions for performing a method comprising:
while the first computer system is presenting, via the one or more output devices, a first audio output:
detecting, via the one or more input devices, a first movement of a first portion of a user of the first computer system;
determining a first user intention based on the first movement of the first portion of the user; and
in response to determining the first user intention:
in accordance with a determination that the first user intention corresponds to an intention of the user to speak, performing a first action, including ceasing the first audio output; and
in accordance with a determination that the first user intention corresponds to a second intention, different from the intention of the user to speak, performing a second action, different from the first action.

20. A non-transitory computer readable storage medium storing one or more programs, the one or more programs comprising instructions, which when executed by one or more processors of an electronic device, cause the electronic device to perform a method comprising:
at a first computer system in communication with one or more input devices and one or more output devices:
while the first computer system is presenting, via the one or more output devices, a first audio output:
detecting, via the one or more input devices, a first movement of a first portion of a user of the first computer system;
determining a first user intention based on the first movement of the first portion of the user; and
in response to determining the first user intention:
in accordance with a determination that the first user intention corresponds to an intention of the user to speak, performing a first action, including ceasing the first audio output; and
in accordance with a determination that the first user intention corresponds to a second intention, different from the intention of the user to speak, performing a second action, different from the first action.
